(19) United States
(12) Patent Application Publication
(10) Pub. No.: US 2023/0298226 A1
(43) Pub. Date: Sep. 21, 2023

(54) SYSTEMS AND METHODS FOR AR/VR DEVICE IMPROVEMENTS

(71) Applicant: Meta Platforms Technologies, LLC, Menlo Park, CA (US)

(72) Inventors: Sanjiban Kundu, Malden, MA (US); Sung Ho Hong, San Jose, CA (US); Cheng-Sheng Hsu, San Jose, CA (US); Yaohui Ye, San Mateo, CA (US); Kiril Georgiev, Sofia, CA (US); Qiuxiang Dong, Santa Clara, CA (US); Junwu Luo, Milpitas, CA (US); David Walsh, Queens, NY (US); Adam Ahne, Snohomish, WA (US); Andrew Doxon, Redmond, WA (US); Ergys Ristani, Bellevue, WA (US); Taylor Douglas Niehues, Snohomish, WA (US); Yan Xu, Kirkland, WA (US); Erin Casey Whitworth, Seattle, WA (US); Prince Gupta, Bothell, WA (US); Karthik Jaiwant Bhandarkar, New York, NY (US); Shenwei Liu, Bellevue, WA (US)

(21) Appl. No.: 18/181,799

(22) Filed: Mar. 10, 2023

Related U.S. Application Data
(60) Provisional application No. 63/319,137, filed on Mar. 11, 2022.
(60) Provisional application No. 63/324,826, filed on Mar. 29, 2022.
(60) Provisional application No. 63/326,000, filed on Mar. 31, 2022.
(60) Provisional application No. 63/346,263, filed on May 26, 2022.
(60) Provisional application No. 63/381,430, filed on Oct. 28, 2022.
(60) Provisional application No. 63/385,353, filed on Nov. 29, 2022.
(60) Provisional application No. 63/481,361, filed on Jan. 24, 2023.

(51) Int. Cl. G06T 11/00; G06Q 50/26; G06T 7/00; G06T 7/10; G06V 20/50; G06F 3/01; G06V 10/70

(52) U.S. Cl. CPC G06T 11/001; G06Q 50/26; G06T 7/0002; G06T 7/10; G06V 20/50; G06F 3/014; G06F 3/017; G06V 10/70; G06T 2207/30168; G06T 2207/20084; G06T 2207/10016; G06T 2207/20081

(57) ABSTRACT

The disclosed computer-implemented methods may include detecting malicious usage based on a user's behavior in connection with a wearable computing device. Similarly, another method may detect a bystander within range of a sensor, in which the device may determine if capturing information associated with a bystander is authorized. Another method may also include performing a segmentation of the media content and detecting a privacy portion of the media content. Furthermore, a method may include identifying a set of image frames and designating an optimal frame for storing. Additionally, a method may include a visibility-based subscription for video streams to determine a subset of the registered participant tiles to be subscribed to and displayed via the display device. Lastly, a system may include a processor that detects the difference of mutual capacitance between a first and second wire. Various other methods, systems, and computer-readable media are also disclosed.

### CROSS-REFERENCE TO RELATED APPLICATIONS

This application claims the benefit of priority under 35 U.S.C. § 119(e) of U.S. Provisional Application No. 63/319,137, filed Mar. 11, 2022, U.S. Provisional Application No. 63/324,826, filed Mar. 29, 2022, U.S. Provisional Application No. 63/326,000, filed Mar. 31, 2022, U.S. Provisional Application No. 63/346,263, filed May 26, 2022, U.S. Provisional Application No. 63/381,430, filed Oct. 28, 2022, U.S. Provisional Application No. 63/385,353, filed Nov. 29, 2022, and U.S. Provisional Application No. 63/481,361, filed Jan. 24, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

The accompanying drawings illustrate a number of exemplary embodiments and are a part of the specification. Together with the following description, these drawings demonstrate and explain various principles of the present disclosure.

FIG. 1 is a diagram of an exemplary environment in which a detection system operates according to one or more implementations.

FIG. 2 is a diagram of an overview of the detection system determining that a wearable computing device is being used maliciously according to one or more implementations.

FIG. 3A is a detailed diagram of the detection system training a user model according to one or more implementations.

FIG. 3B is a detailed diagram of the detection system detecting malicious usage of a wearable computing device and causing one or more events to occur based on the detected malicious usage according to one or more implementations.

FIGS. 4A and 4B are illustrations of an exemplary human-machine interface configured to be worn around a user's lower arm or wrist.

FIGS. 5A, 5B, and 5C are illustrations of an exemplary schematic diagram with internal components of a wearable system.

FIG. 6 is a flow diagram of an exemplary method for camera frame selection.

FIG. 7 is an illustration of exemplary camera frames.

FIG. 8 is a flow diagram of an exemplary method for augmenting media to preserve quality and privacy.

FIG. 9 is a block diagram of an exemplary system for augmenting media to preserve quality and privacy.

FIG. 10 is an illustration of an exemplary color change pattern transmitted between devices during pairing, according to some embodiments.

FIG. 11 is a flow diagram of an exemplary method for pairing devices that includes the use of a color change pattern, according to some embodiments.

FIG. 12 is a flow diagram of an exemplary method for pairing devices that includes the use of a color change pattern, according to some embodiments.

FIG. 13 is an illustration showing an assembly with its complimentary parts according to some embodiments.

FIG. 14 is an illustration showing a prospective view of a surface of a wearable device with its complimentary parts according to some embodiments.

FIG. 15 illustrates a system configured for a visibility-based subscription for video calls, in accordance with one or more implementations.

FIG. 16 illustrates a method for a visibility-based subscription for video calls, in accordance with one or more implementations.

FIG. 17 is a block diagram illustrating an example computer system (e.g., representing both client and server) with which aspects of the subject technology can be implemented.

FIG. 18 is an illustration of exemplary augmented-reality glasses that may be used in connection with embodiments of this disclosure.

FIG. 19 is an illustration of an exemplary virtual-reality headset that may be used in connection with embodiments of this disclosure.

FIG. 20 is an illustration of exemplary haptic devices that may be used in connection with embodiments of this disclosure.

FIG. 21 is an illustration of an exemplary virtual-reality environment according to embodiments of this disclosure.

FIG. 22 is an illustration of an exemplary augmented-reality environment according to embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Detecting Malicious Usage with Wearable Devices

Wearable computing devices have become increasingly powerful and omnipresent. For example, wearable computing devices can include enhanced eyewear, head-mounted computing devices, smartwatches, and other smart wearable devices. These devices can include computational features including, for example, health monitoring capabilities, network connectivity capabilities, digital display capabilities, and telecommunication capabilities.

Problems arise as these wearable computing devices become smaller and more ubiquitous. For example, due to the small form factor common to many wearable devices, such devices can be easily lost, mislaid, and even stolen. When such an event occurs, malicious usage of a wearable device can result. For example, malicious usage can include accessing private information, making fraudulent purchases, and impersonating the device owner across various social platforms. As such, a need exists for a system that detects malicious usage in connection with wearable devices and then takes appropriate action in light of the detected malicious usage.

The present disclosure is generally directed to a detection system that can model user's behaviors to detect malicious usage in connection with wearable computing devices and then react to the malicious usage in various ways. As will be explained in greater detail below, embodiments of the present disclosure may utilize analytics data associated with a user to generate a computational model of that user's behavior. Embodiments of the present disclosure can then apply the computational model to additional analytics data received from a wearable computing device to generate a prediction as to whether the device is being used maliciously. Based on a confidence level associated with the prediction, embodiments of the present disclosure can further take any of a variety of actions relative to the wearable device. For example, embodiments of the present disclosure may send a notification to the user of the wearable device if a confidence level associated with the prediction is low. In another example, embodiments of the present disclosure may remotely wipe the wearable device if the confidence level associated with the prediction is high.

Features from any of the embodiments described herein may be used in combination with one another in accordance with the general principles described herein. These and other embodiments, features, and advantages will be more fully understood upon reading the following detailed description in conjunction with the accompanying drawings and claims.

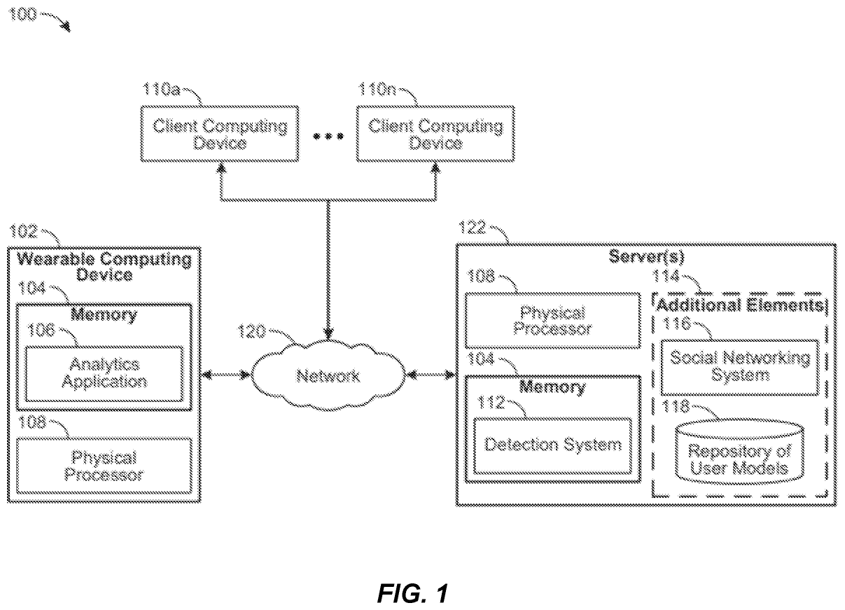

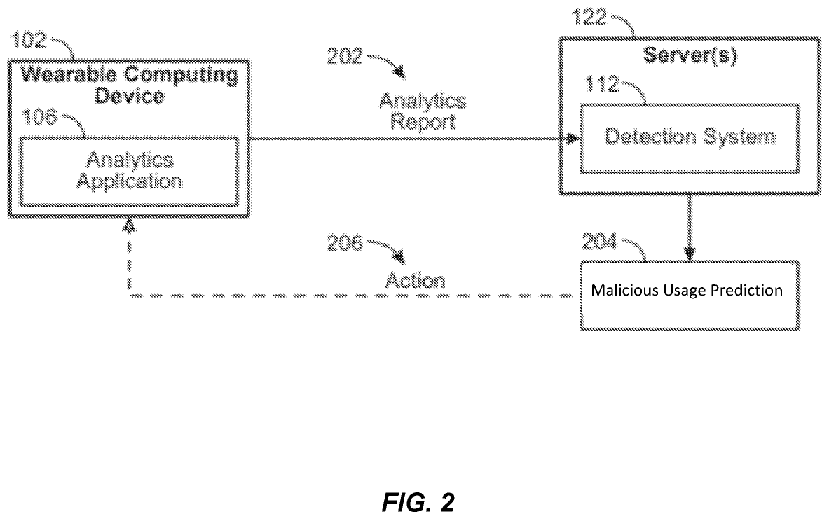

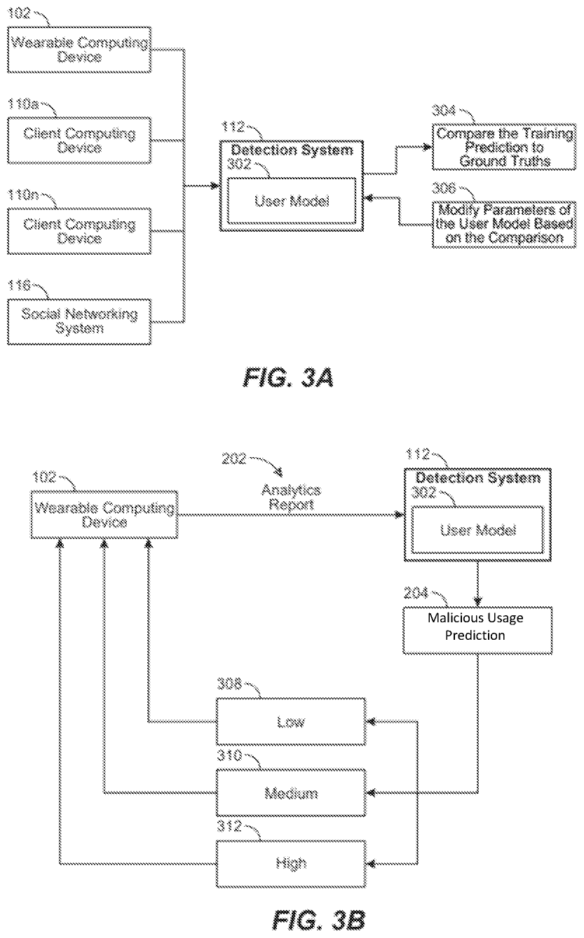

The following will provide detailed descriptions of the detection system in connection with a wearable computing device. For example, FIG. 1 illustrates the detection system operating in an environment that includes a user's wearable computing device, as well as other computing devices associated with the user. FIG. 2 illustrates an overview of the detection system detecting malicious usage of a wearable computing device and determining a level of action in light of the detected malicious usage. FIG. 3A illustrates a diagram of the detection system generating and training a computational model of a user's behavior relative to a wearable computing device, while FIG. 3B illustrates a diagram of the detection system applying the trained computational model of the user's behavior against updated analytical data from the wearable computing device.

As mentioned above, FIG. 1 is a diagram of a network environment 100 wherein a detection system 112 can operate in connection with other computing devices. For example, as shown in FIG. 1, the network environment 100 can include a wearable computing device 102, other client computing devices 110a-110n, and a server(s) 122. In one or more embodiments, the wearable computing device 102—and in some configurations the client computing devices 110a-110n—can include a physical processor 108 and a memory 104 including an analytics application 106. Additionally, the server(s) 122 can include a physical processor 108, a memory 104 including the detection system 112, and additional elements 114 including a social networking system 116 and a repository of user models 118.

In one or more configurations, the wearable computing device 102 and the client computing devices 110a-110n can be associated with the same user. For example, the wearable computing device 102 can be a smart watch associated with the user, while the client computing devices 110a-110n can include a smart phone associated with the user, a tablet computing associated with the user, and a laptop associated with the user. Accordingly, in some configurations, the wearable computing device 102 as well as the client computing devices 110a-110n can generate and provide analytics data to the server(s) 122 in connection with the same user.

In some examples, the analytics application 106 can generate analytics reports associated with usage of the wearable computing device 102. For example, the analytics application 106 can generate an analytics report that details applications that are initialized and used on the wearable computing device 102, time spent in different applications on the wearable computing device 102, order of application usage on the wearable computing device 102, and activities performed within the applications on the wearable computing device 102. The analytics application 106 can generate analytics reports on a regular schedule (e.g., every 10 minutes), or can generate analytics reports on request. In some examples, the analytics application 106 can automatically transmit analytics reports to the detection system 112.

In one or more configurations, the client computing devices 110a-110n can each include similar analytical tools. For example, any of the client computing devices 110a-110n can include analytical tools that collect usage data relative to one or more applications installed thereon to generate analytical reports. In some examples, these analytical tools can also automatically transmit these additional analytical reports to the detection system 112.

As further shown in FIG. 1, the server(s) 122 can feature the memory 104 including the detection system 112. As will be discussed in greater detail, the detection system 112 generates and trains user-specific behavioral models and applies those models against analytical data from wearable computing devices. In one or more configurations, the detection system 112 can utilize the trained user models to determine whether a user's wearable device is being maliciously used. The detection system 112 can take further action depending on confidence levels associated malicious usage predictions.

In some configurations, the server(s) 122 can feature additional elements 114 that can include a social networking system 116 and a repository of user models 118. For example, the social networking system 116 can include various social networking features supported by a social graph of users that are connected in various ways. In at least one example, the detection system 112 can utilize information associated with a user within the social networking system 116 to further train a user model associated with that user. Additionally, the detection system 112 can store and access user models within the repository of user models 118.

The wearable computing device 102 and the client computing devices 110a-110n may be communicatively coupled to the server(s) 122 through a network 120. The network 120 may represent any type or form of communication network, such as the Internet, and may comprise one or more physical connections, such as a LAN, and/or wireless connections, such as a WAN.

Although FIG. 1 illustrates components of the network environment 100 in one arrangement, other arrangements are possible. For example, in one configuration, the detection system 112 and/or social networking system 116 may exist across multiple networked servers. In additional configuration, the network environment 100 can include any number of computing devices such that there are multiple wearable computing device users represented along with client computing devices associated with each wearable computing device user represented within the network environment 100. Alternatively, in at least one configuration, the network environment 100 may include the wearable computing device 102 with no additional client computing devices associated with the user.

As mentioned above, FIG. 2 illustrates an overview diagram of the detection system 112 generating a malicious usage prediction relative to the wearable computing device 102. For example, the analytics application 106 installed on the wearable computing device 102 can generate and transmit an analytics report 202 to the detection system 112 on the server(s) 122. In one or more implementations, the analytics application 106 can generate the analytics report 202 including usage information relative to the wearable computing device 102. For instance, the analytics application 106 can generate the analytics report 202 including information indicating applications that have been initialized, applications that have been used, use-time associated with each application, use order associated with applications that have been used, and activity that has occurred relative to each application.

Upon receiving the analytics report 202 from the wearable computing device 102, the detection system 112 can run a user model against the analytics report 202 to generate a malicious usage prediction 204. For example, the analytics application 106 can transmit the analytics report 202 along with an identifier associated with a user of the wearable computing device 102. The detection system 112 can then identify a trained user model that corresponds to the received identifier.

In one or more configurations, the detection system 112 can generate the malicious usage prediction 204 by applying the identified user model to all or aggregations of the analytics report 202. For example, in some configurations, the identified user model can include a recurrent neural network (RNN) trained to generate predictions as to whether malicious usage of a wearable computing device has occurred based on updated usage information relative to the wearable computing device. In one or more configurations, the generated malicious usage prediction 204 can include a confidence level or percentage indicating certainty as to whether malicious usage has occurred or is occurring on the wearable computing device 102. To illustrate, the malicious usage prediction 204 of 83% can indicate that there is 83% chance that malicious usage of the wearable computing device 102 is occurring based on the analytics report 202.

The detection system 112 can cause various events to occur depending on the malicious usage prediction 204. For example, in some configurations, the detection system 112 can cause an action 206 to occur when the malicious usage prediction 204 falls within one of several ranges. To illustrate, the detection system 112 can cause a low-level intervention to occur if the malicious usage prediction 204 falls within a “low” range (e.g., 50%-60%). Similarly, the detection system 112 can cause a medium-level intervention to occur if the malicious usage prediction 204 falls within a “medium” range (e.g., 61%-80%). Additionally, the detection system 112 can cause a high-level intervention to occur if the malicious usage prediction 204 falls within a “high” range (e.g., 81%-100%). The levels of intervention are discussed in greater detail below with regard to FIG. 3B.

As mentioned above, the detection system 112 can generate and train a computational model of a user's usage behaviors based on aggregations of usage data associated with that user. FIG. 3A illustrates a diagram of the detection system 112 generating and training a user model 302. For example, as shown in FIG. 3A, the detection system 112 can receive usage data from one or more sources. In one or more configurations, the detection system 112 can receive usage data from the wearable computing device 102. As discussed above, the detection system 112 can receive usage data that indicates applications utilized by the user of the wearable computing device 102, times of day and days of the week that applications are utilized, amounts of time that the user spent utilizing those applications, orders in which the applications are utilized, and activity that occurred while the applications were utilized (e.g., activities including messaging, taking photos, telecommunication activities, social networking system activities).

In additional configurations, the detection system 112 can receive usage data associated with the user of the wearable computing device 102 from other sources. For example, the detection system 112 can receive usage data from one or more of the client computing devices 110a-110n. To illustrate, the detection system 112 can receive usage data including, but not limited to, applications utilized on the client computing devices 110a-110n, time spent utilizing those applications, order in which those applications were utilized, and activities performed while utilizing those applications. In some implementations (e.g., when the wearable computing device 102 is brand new with little to no usage data), the detection system 112 can generate the user model 302 based primarily on the usage data received from the client computing devices 110a-110n.

Moreover, the detection system 112 can further receive usage data associated with the user of the wearable computing device 102 from the social networking system 116. For example, the detection system 112 can receive usage data including social networking system activity associated with the user of the wearable computing device 102, social graph information associated with the user of the wearable computing device 102, and social networking system activity information associated with co-users of the user of the wearable computing device 102.

In example configurations, the detection system 112 utilizes one or more of the various types of usage data to train the user model 302. For example, the user model 302 can be an RNN utilizing a long-short term memory (LSTM) architecture. To illustrate, a RNN model can be useful for detecting anomalies in time-series data sets because RNNs can be trained to hold knowledge of the past. This can make an RNN a logical choice for generating a computational model of a user's usage behavior over time. The detection system 112 can generate the user model 302 including any number of time steps in any of a variety of RNN types and/or architectures. In alternative configurations, the detection system 112 can generate the user model 302 including a different type or architecture of neural network, decision tree, algorithm, and so forth.

The detection system 112 can train the user model 302 over multiple training cycles utilizing aggregations of the usage data received from one or more of the sources discussed above. For example, as shown in FIG. 3A, the detection system 112 can train the user model 302 by propagating an aggregation of the usage data forward through the user model 302 to generating a training prediction as to whether the aggregated usage data indicates that malicious usage has occurred. The detection system 112 can further perform an act 304 of comparing the training prediction to a ground truth regarding the aggregated usage data. Next, the detection system can perform an act 306 of modifying parameters of the user model 302 based on the comparison. For example, the detection system 112 can compute an error represented by the comparison performed in the act 304. The detection system 112 can then back-propagate that error through the user model 302 by updating weights associated with the nodes within the various time steps. In one or more configurations, the detection system 112 can repeat this training cycle many times until the determined error converges.

At this point, the detection system 112 can consider the user model 302 “trained.” Once trained, the detection system 112 can store the user model 302 (e.g., within the repository of user models 118 discussed above with regard to FIG. 1) in connection with the user of the wearable computing device 102. For example, the detection system 112 can index the user model 302 within the repository of user models 118 based on a unique identifier associated with the user of the wearable computing device 102. To illustrate, the detection system 112 can index the user model 302 based on a social networking system username, an email address, a phone number, or another randomly generated unique identifier.

In some implementations, the detection system 112 can periodically re-train the user model 302. For example, the detection system 112 can re-train the user model 302 on a predetermined schedule (e.g., once a week). Additionally, the detection system 112 can re-train the user model 302 in response to determining that the usage data associated with the user has shifted over time (e.g., rather than suddenly as with detected malicious usage). In this way, the detection system 112 can re-train the user model 302 to accurately reflect the user's behavior relative to the wearable computing device 102 over time.

As mentioned above, the detection system 112 can apply a trained user model to unknown inputs (e.g., an updated analytics report from the wearable computing device 102) to generate a malicious usage prediction indicating a likelihood that the wearable computing device 102 is being used maliciously. FIG. 3B is a diagram illustrating the detection system 112 applying the user model 302 to the analytics report 202 from the wearable computing device to generate the malicious usage prediction 204. For example, the detection system 112 can generate an input vector based on all or aggregations of the analytics report 202. In additional or alternative configurations, the detection system 112 can generate the input vector including additional weights associated with the usage information therein.

To illustrate, the detection system 112 can add additional weight to usage data such as the order in which applications are utilized on the wearable computing device 102. In one or more configurations, the detection system 112 then generates the malicious usage prediction 204 by applying the user model 302 to the generated input vector. In one or more implementations, the wearable computing device 102—and other computing devices and social networks, etc.—can transmit analytics reports to the detection system 112 regularly (e.g., every 5 minutes). Additionally, in come implementations, the detection system 112 can request analytics reports regularly. Moreover, the detection system 112 can generate an input vector based on every received analytics reports. Conversely, the detection system 112 can generate an input vector for only some of the received analytics reports (e.g., every other received report, every fifth received report).

As mentioned above, the user model 302 can generate the malicious usage prediction 204 as a percentage that indicates a likelihood that malicious usage has occurred or is occurring in connection with the wearable computing device 102. In one or more configurations, the detection system 112 can cause different levels or severities of events or actions to occur based on a tier into which the malicious usage prediction 204 falls. For example, in one configuration, the detection system 112 can determine that the malicious usage prediction 204 corresponds with a low tier 308, a medium tier 310, or a high tier 312.

To illustrate, the detection system 112 can determine that the malicious usage prediction 204 corresponds with the low tier 308 when the malicious usage prediction 204 falls between 60% and 75%. Additionally, the detection system 112 can determine that the malicious usage prediction 204 corresponds with the medium tier 310 when the malicious usage prediction 204 falls between 76% and 85%. Moreover, the detection system 112 can determine that the malicious usage prediction 204 corresponds with the high tier 312 when the malicious usage prediction 204 falls between 86% and 100%. In some configurations, the tiers 308, 310, and 312 may be user-configurable. Additionally, in some configurations, the tiers 308, 310, and 312 may correspond with any percentage ranges (e.g., 70%-79%, 80%-89%, 90%-99%, etc.).

As mentioned above, the detection system 112 can cause different events to occur based on the tier into which the malicious usage prediction 204 falls. For example, when the malicious usage prediction 204 falls into the low tier 308, the detection system can cause a low-intervention event to occur. Similarly, when the malicious usage prediction 204 falls into the medium tier 310, the detection system can cause a medium-intervention event to occur. Additionally, when the malicious usage prediction 204 falls into the high tier 312, the detection system can cause a high-intervention event to occur.

To illustrate, a low-intervention event can include generating and sending a notification to another device associated with the user of the wearable computing device 102 (e.g., one or more of the client computing devices 110a-110n). For example, the detection system 112 can generate a notification including an email, an electronic message, a popup notification, or an SMS text message. In some configurations, the detection system 112 can generate the notification including user-selectable options for a next-step (e.g., lock the wearable computing device 102, provide a (Global Positioning System) GPS location of the wearable computing device 102, ignore the notification).

Additionally, a medium-intervention event can include remotely locking the wearable computing device 102. For example, the detection system 112 can transmit a message or code to the wearable computing device 102 that causes the wearable computing device 102 to lock itself. In more detail, the detection system 112 can transmit a lock code to the wearable computing device 102 such that the wearable computing device 102 becomes non-functional and can only be unlocked in response to receiving a code, fingerprint, or other biometric reading from the user of the wearable computing device 102.

Moreover, a high-intervention event can include remotely wiping the wearable computing device 102. For example, the detection system 112 can transmit a message or code to the wearable computing device 102 that causes the wearable computing device 102 to delete all or some of the information stored on its internal memory. In at least one configuration, the detection system 112 can cause the wearable computing device 102 to transmit its current GPS location prior to remotely wiping itself.

As such, the detection system 112 provides an accurate and efficient way to provide wearable computing devices from malicious use. For example, as discussed above, the detection system 112 generates models of a user's behavior based on how they use their wearable computing device, in addition to how they use their other client computing devices and social networking systems. Once a user's model is trained, the detection system 112 can apply the model to usage analytics data associated with the user to generate a malicious usage prediction. Depending on the strength of the prediction, the detection system 112 can take various actions in connection with the user's wearable computing device in order to protect the user from potential undesirable outcomes from the detected malicious use of that device.

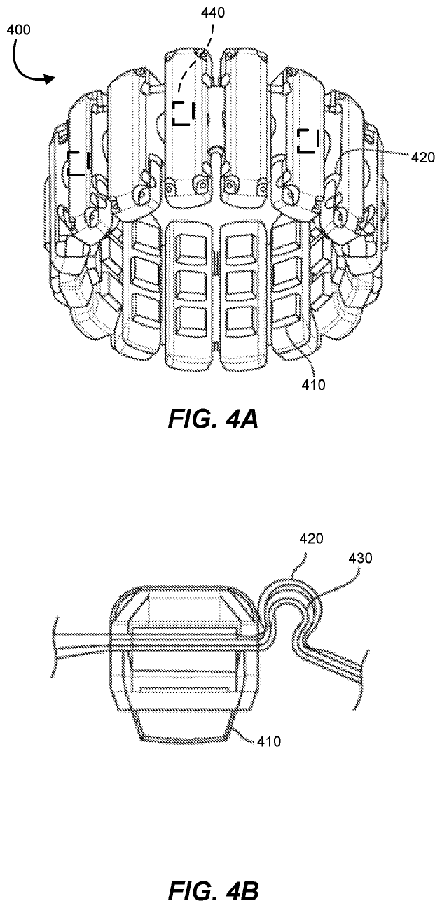

FIG. 4A illustrates an exemplary human-machine interface (also referred to herein as an EMG control interface) configured to be worn around a user's lower arm or wrist as a wearable system 400. In this example, wearable system 400 may include sixteen neuromuscular sensors 410 (e.g., EMG sensors) arranged circumferentially around an elastic band 420 with an interior surface 430 configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device.

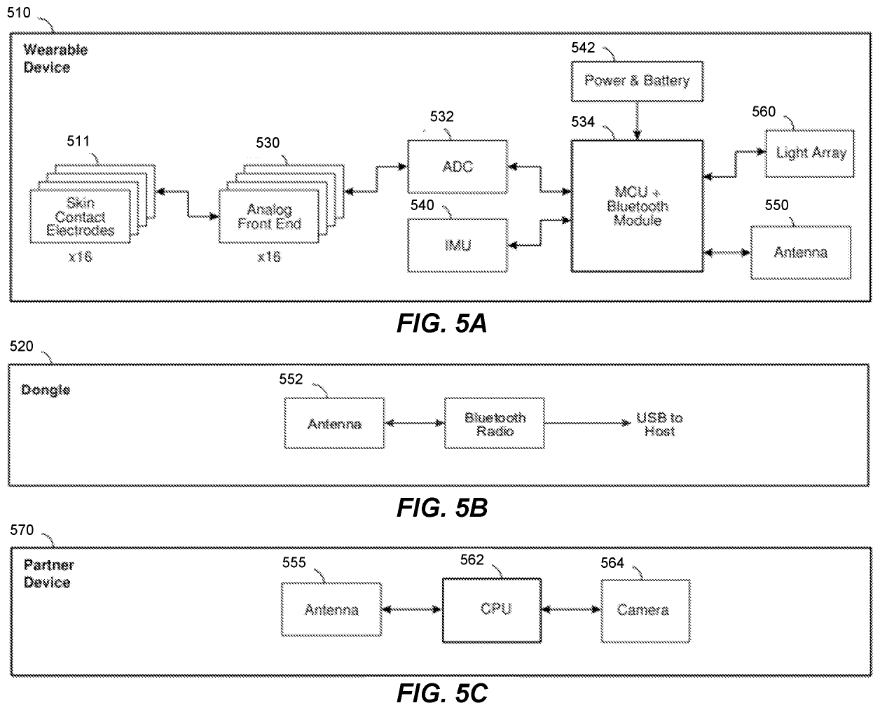

FIG. 4B illustrates a cross-sectional view through one of the sensors of the wearable device shown in FIG. 4A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 410 is discussed in more detail below with reference to FIGS. 5A and 5B.

FIGS. 5A and 5B illustrate an exemplary schematic diagram with internal components of a wearable system with EMG sensors. As shown, the wearable system may include a wearable device 510 (FIG. 5A) and a dongle 520 (FIG. 5B) in communication with the wearable device 510 (e.g., via Bluetooth or another suitable wireless communication technology). As shown in FIG. 5A, the wearable device 510 may include skin contact electrodes 511, examples of which are described in connection with FIGS. 5A and 5B. The output of the skin contact electrodes 511 may be provided to analog front end 530, which may be configured to perform analog processing (e.g., amplification, noise reduction, filtering, etc.) on the recorded signals. The processed analog signals may then be provided to analog-to-digital converter 532, which may convert the analog signals to digital signals that can be processed by one or more computer processors. An example of a computer processor that may be used in accordance with some embodiments is microcontroller (MCU) 534, illustrated in FIG. 5A. As shown, MCU 534 may also include inputs from other sensors (e.g., IMU sensor 540), and power and battery module 542. The output of the processing performed by MCU 534 may be provided to antenna 550 for transmission to dongle 520 shown in FIG. 5B.

Dongle 520 may include antenna 552, which may be configured to communicate with antenna 550 included as part of wearable device 510. Communication between antennas 550 and 552 may occur using any suitable wireless technology and protocol, non-limiting examples of which include radiofrequency signaling and Bluetooth. As shown, the signals received by antenna 552 of dongle 520 may be provided to a host computer for further processing, display, and/or for effecting control of a particular physical or virtual object or objects.

Camera Frame Selection

When a camera is streaming, the camera may continuously save multiple frames (typically between 3 and 10) in its ring buffer, replacing oldest frame with the newest frame as new frames are captured. When the user presses the capture button, the camera system may select one of the frame in the buffer to save as a final image. If the frame selection algorithm is not smart enough (e.g., an arbitrary frame is selected, the oldest frame is selected, etc.), the quality of final saved frame may be significantly impacted. For example, the image may be motion blurred by hand shaking, brightness or color may be wrong if the frame was in the middle of convergence, the frame may be occluded by fingers, and so on.

The present disclosure is generally directed to systems and methods for automatically selecting the optimal frame (e.g., most correct color, least motion blur, etc.) among all frames in the buffer. In one embodiment, the systems described herein may measure the sharpness of the frame as the optimal frame selection criteria. In some examples, a sharpness measurement may be effective enough to measure many factors of image quality, such as motion blur, brightness, color balance, etc. As will be explained in greater detail below, embodiments of the present disclosure may enhance the functioning of a computing device by improving the ability of the computing device to select an optimal frame from a camera stream buffer. Additionally, the systems described herein may improve the fields of videography and/or photography by improving the quality of image and/or video frames stored from a frame buffer.

Features from any of the embodiments described herein may be used in combination with one another in accordance with the general principles described herein. These and other embodiments, features, and advantages will be more fully understood upon reading the following detailed description in conjunction with the accompanying drawings and claims.

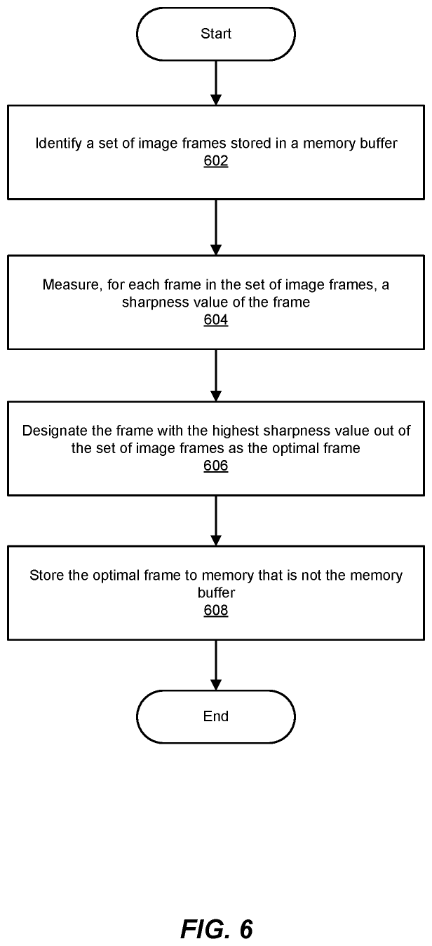

FIG. 6 is a flow diagram of an exemplary computer-implemented method 600 for camera frame selection. The steps shown in FIG. 6 may be performed by any suitable computer-executable code and/or computing system. In one example, each of the steps shown in FIG. 6 may represent an algorithm whose structure includes and/or is represented by multiple sub-steps, examples of which will be provided in greater detail below.

As illustrated in FIG. 6, at step 602 one or more of the systems described herein may identify a set of image frames stored in a memory buffer. The term “image frame” or “frame” generally refers to any static digital representation of visual data. In one embodiment, an image frame may include a two-dimensional array of pixels. In some examples, image frames may be captured by the camera of a device at fixed intervals (e.g., every millisecond, every ten milliseconds, every second, etc.) and/or in response to user input (e.g., pressing and/or holding a “record” or “capture” button). The term “memory buffer,” generally refers to any physical and/or virtual memory that temporarily stores data. In some embodiments, a memory buffer may store a limited quantity of frames, such as three frames, five frames, or ten frames and/or may replace the oldest frame in the buffer with a new frame each time the camera captures a new frame.

At step 604, the systems described herein may measure, for each frame in the set of image frames, a sharpness value of the frame. The term “sharpness” may generally refer to any measurement of the clarity and/or level of detail of an image.

In some embodiments, the systems described herein may pre-process the frame before calculating the sharpness value. For example, the systems described herein may retrieve the luminance data for the frame and calculate the sharpness value based on the luminance alone. Additionally, or alternatively, the systems described herein may downscale the frame to mitigate noise.

The systems described herein may measure the sharpness value in a variety of ways. For example, the systems described herein may perform a horizontal diff of the frame (i.e., shift each pixel one position over horizontally and take the difference of the resulting and original images) and a vertical diff of the frame and sum the two diffs to arrive at the sharpness value. Additionally, or alternatively, the systems described herein may apply a high pass filter, such as a Laplacian filter, Sobel filter, and/or any other relevant edge detection algorithm to arrive at the sharpness value.

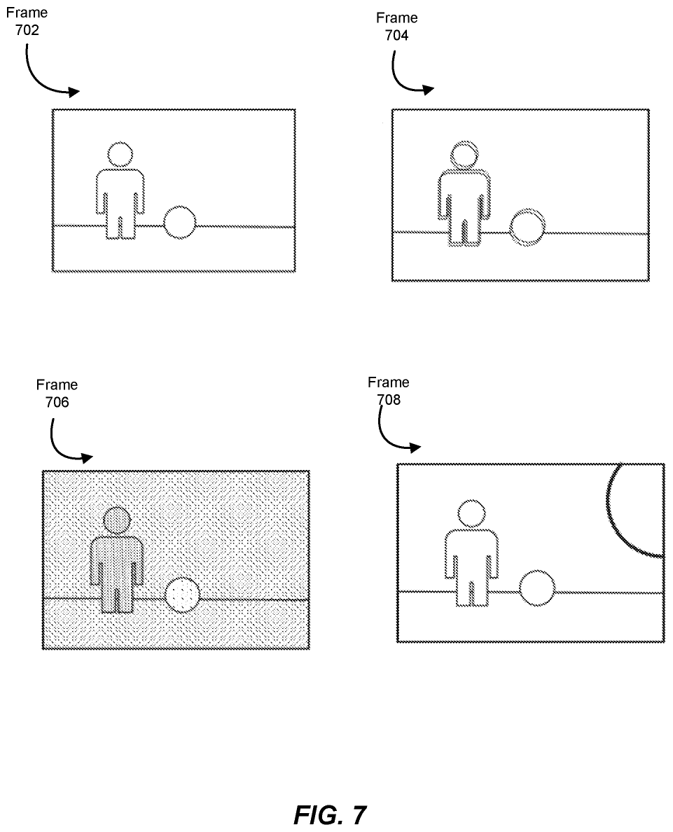

At step 606, the systems described herein may designate the frame with the highest sharpness value out of the set of image frames as the optimal frame. In some examples, the optimal frame may be the frame least affected by motion blur, occlusions, and/or inaccurate colors. For example, as illustrated in FIG. 7, a camera may store frames 702, 704, 706, and/or 708 in a memory buffer. In one example, frame 702 may have the highest sharpness value, while frame 1204 may have a lower sharpness value due to motion blur, frame 706 may have a lower sharpness value due to low brightness, and/or frame 708 may have a lower sharpness value due to a finger partially occluding the image.

Returning to FIG. 6, at step 608, the systems described herein may store the optimal frame to memory that is not the memory buffer. For example, the systems described herein may store the optimal frame to longer-term-storage memory that stores saved images captured by the camera. In some embodiments, the systems described herein may select and/or store the optimal frame in response to user input that triggers frame storage, such as a user pressing a “capture” button on the camera.

As discussed above in connection with FIG. 6, the systems and methods described herein may improve the functioning of a camera by efficiently selecting the optimal frame out of a set of frames stored in a buffer. Because the systems described herein select the optimal frame by calculating a sharpness value for each frame, the systems described herein may consume minimal computing resources (e.g., central processing unit time, memory, battery power, etc.) compared to more complex algorithms. By selecting the optimal frame from the buffer based on sharpness value, the systems described herein may reduce the occurrence of motion blur, incorrect colors, occlusions, and/or other negative qualities in captured images.

Augmenting Media to Preserve Quality and Privacy

With the rising popularity of artificial reality, such as virtual reality or augmented reality, the use of artificial reality devices may allow users to easily take photos and videos of their surroundings. However, this may lead to an issue with bystander privacy because users may actively or passively capture moments that may be invasive to other people's privacy. For example, a user may inadvertently capture a person who happens to be in the vicinity of the user using an artificial reality device.

Many privacy solutions may focus on maintaining the privacy of the user rather than the privacy of persons captured in the user's media. For instance, many platforms such as social media platforms may provide end-to-end encryption and anonymization features to protect the user's privacy by removing user-identifiable information. However, such solutions may not provide adequate privacy protection for subjects within the media. In addition, the user may also access a local copy of the media that may breach the privacy of the subjects in the media, such as building addresses, car license plates, people's faces and/or voices, etc.

Certain privacy solutions may transform media to remove potentially private information. For example, private information may be cropped out, voices may be muted, and/or the media may be otherwise altered such as by rotating, applying filters, etc. to obfuscate the private information. More advanced techniques may include blurring or inpainting private information (e.g., faces, license plates, etc.) or removing the private information from the media (e.g., removing people in a background of an image). However, such solutions may create a distracting effect in which the altered or removed portions may be noticeable. For example, a photo in front of a landmark may include various bystanders in its background. Blurring out or removing the people may create a jarring visual presentation.

The present disclosure is generally directed to augmenting media to preserve quality and privacy. As will be explained in greater detail below, embodiments of the present disclosure may perform segmentation on media content and detect, based on the segmentation, a privacy portion of the media content. By generating synthetic data corresponding to the privacy portion and replacing, in the media content, the privacy portion with the synthetic data, the systems and methods herein may generate augmented media content that may preserve quality and privacy.

Features from any of the embodiments described herein may be used in combination with one another in accordance with the general principles described herein. These and other embodiments, features, and advantages will be more fully understood upon reading the following detailed description in conjunction with the accompanying drawings and claims.

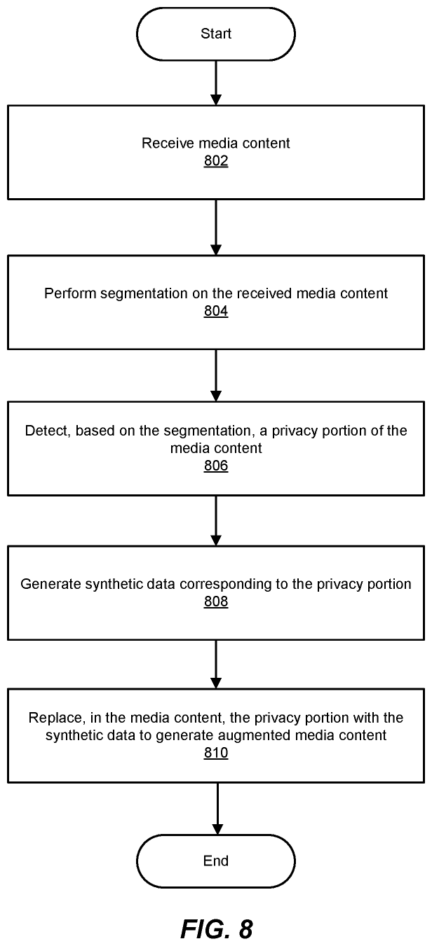

FIG. 8 is a flow diagram of an exemplary computer-implemented method 800 for augmenting media to preserve quality and privacy. The steps shown in FIG. 8 may be performed by any suitable computer-executable code and/or computing system. In one example, each of the steps shown in FIG. 8 may represent an algorithm whose structure includes and/or is represented by multiple sub-steps, examples of which will be provided in greater detail below.

As illustrated in FIG. 8, at step 802 one or more of the systems described herein may receive media content. The systems described herein may perform step 802 in a variety of ways. In one example, the media content may be received and stored locally.

At step 804 one or more of the systems described herein may perform segmentation on the received media content. In some embodiments, the term “segmentation” may refer to partitioning digital media into segments (e.g., sets of pixels), for instance by identifying and labeling each pixel to a class that may correspond to an object. Segmentation may include, for example, image processing, computer vision, etc. Segmentation may facilitate further analysis of segmented portions. The systems described herein may perform step 804 in a variety of ways. In one example, the segmentation may include at least one of pose segmentation, face segmentation, address segmentation, surroundings segmentation, voice segmentation, or license plate segmentation.

At step 806 one or more of the systems described herein may detect, based on the segmentation, a privacy portion of the media content. In some embodiments, the term “privacy portion” may refer to portions of a media content that have been identified as potentially private. For example, a privacy portion of a media content may correspond to faces, certain text (e.g., addresses, license plate numbers, etc.) recognizable objects, private locations (e.g., a person's bedroom, office, etc.) that are captured in the media content. The systems described herein may perform step 806 in a variety of ways. In one example, detecting the privacy portion may be based on a privacy score applied to each segmented element. For instance, the privacy score may be based on at least one of a face orientation, a media metadata, a location, or user settings. The user settings may include user selected persons or objects that are not considered private.

At step 808 one or more of the systems described herein may generate synthetic data corresponding to the privacy portion. In some embodiments, the term “synthetic data” may refer to artificially generated data that may resemble genuine data. Synthetic data for objects detected in media content may include an artificially generated instance of the objects. For example, if a face is detected in media content, a corresponding synthetic data for the face may include an artificially generated face that may appear to be a real face but may not correspond to any actual person's face. The systems described herein may perform step 808 in a variety of ways. In one example, the synthetic data is generated by a generative adversarial network (“GAN”). In some embodiments, the term “GAN” may refer to a machine learning scheme in which two neural networks, a generator and a discriminator. The generator may be trained, using a training set of authentic data (e.g., real photographs), to generate data (e.g., artificial photographs) that include realistic characteristics that may appear superficially authentic. The discriminator may be trained to evaluate how realistic an input data may be. Thus, the generator may generate candidate data until the discriminator determines the candidate data to not be synthetic. In some examples, the synthetic data may be generated using other machine learning schemes. In some examples, the synthetic data may be generated locally.

At step 810 one or more of the systems described herein may replace, in the media content, the privacy portion with the synthetic data to generate augmented media content. In some embodiments, the term “augmented media content” may refer to media content that has been altered, which may correspond to an improvement to the media content. For example, as described herein, media content may be augmented by replacing privacy portions with synthetic data. In some examples, the method may further include uploading the augmented media content to a remote device, such as a social media platform.

As described herein, semantic segmentation techniques may be used to granularly segment the portions of media, which may then be run through detection models to identify if they are privacy invasive or not. If one or more of the segmented portions of media are identified as privacy invasive, GAN models may be used to replace the segmented portions with synthetic data.

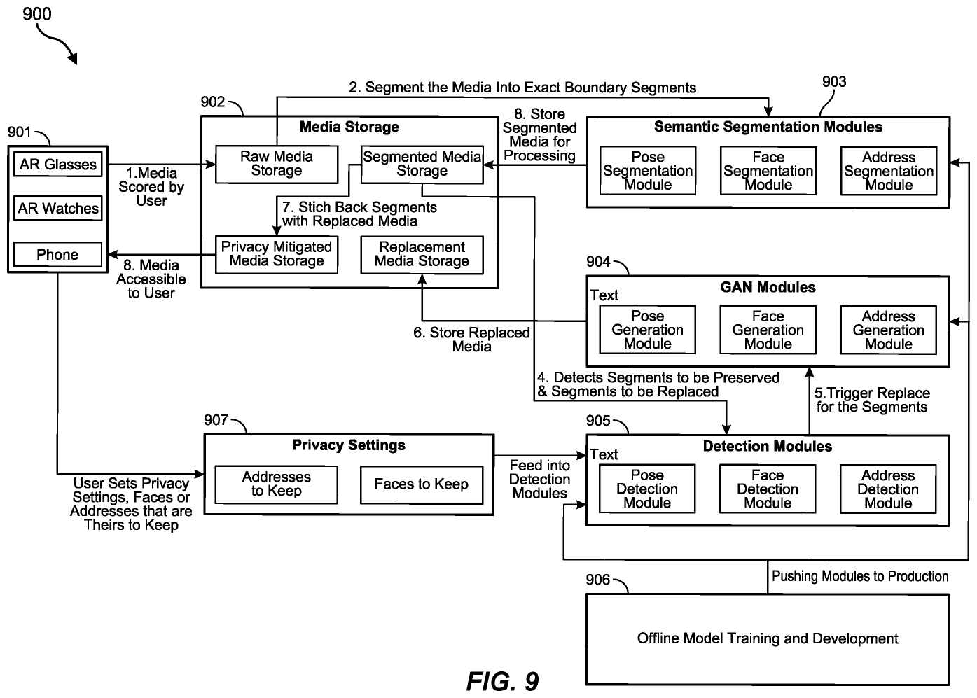

In reference to user environment 900 in FIG. 9, a user may capture media using a computing device 901, which may correspond to a user device such as a mobile device, laptop, etc. and/or may correspond to an artificial reality device, such as augmented reality glasses, augmented reality watch, etc. The media may be stored locally on a media storage 902, which may correspond to a storage device connected to or integrated with computing device 901. Segmentation modules 903 may then perform segmentation techniques to segment the data to faces, surroundings, poses, addresses, license plates etc.

After segmentation, detection modules 905 may be run on the segmented data to determine whether they cross a privacy score threshold. For example, detection modules 905 may use features such as where faces are looking (directly at the camera or not), media metadata such as a location which can map to the user's house, etc. In addition, the privacy score may be calculated and analyzed for each segmented element. Once the privacy score value crosses a privacy threshold, the media may be fixed. However, detection modules 905 may also check privacy settings 907 to determine whether a particular element should remain unmodified.

This process may occur locally with a companion app, or remotely on a server. The user may be required to give consent for the server processing in order to protect other people's privacy. GAN models 904 may be used to generate synthetic data to replace the privacy invasive portions of the media. Thus, a synthetic face may be displayed, rather than a blur or a black box. This process may also be applied to other forms of media, such as videos, audio (e.g., voice), etc.

Moreover, in some examples, segmentation modules 903, GAN modules 904, and/or detection modules 905 may undergo offline model training 906. In some examples, offline model training 906 may be a global training of models that may be propagated to computing device 901. In some examples, offline model training 906 may occur locally on computing device 901.

As described herein, if a media crosses a privacy invasive threshold >X, then the media may be prevented from being locally stored. Alternatively, if the privacy score crosses a certain threshold, then the media may be restricted to certain action such as server side or companion app side processing.

In some examples, after a media is saved locally, users may opt into cloud processing which may convert the media into a privacy safe media. By leveraging cloud computing services in this manner, the impact on the user device's battery may be reduced.

In some examples, users may select the items that should not be marked as privacy invasive. For example, the user may wish for their own voice and face, as well as the voices and faces of family and friends, to be preserved. The user may also be able to make a final decision as to which portions of the media to replace. For example, the user may normally wish to replace persons that are not family or friends, but for particular instances (e.g., a photo with a celebrity) may wish to override the normal settings.

In some examples, the replacement may replace inappropriate portions of media, such as offensive language or images. For example, the user may have captured a person saying offensive words. Detection modules 905 may be further configured to detect offensive content, which may be replaced with non-offensive synthetic content generated by GAN modules 904. Thus, the systems and methods herein may replace private or offensive portions of media content with realistic synthetic content to generate augmented media that may preserve quality and privacy.

Color Changing Pattern for Device Pairing

Bluetooth Low Energy (BLE) is a commonly used wireless standard for securely connecting devices that are in relatively close proximity to each other. However, processes for pairing devices via BLE may present security issues that can put user data and/or control of the devices at risk. For example, conventional BLE pairing processes may expose the devices to various third-party attacks, such as passive eavesdropping, man-in-the-middle (MITM) attacks, and identity tracking exploits. Out of Band (OOB) pairing may be used to prevent such attacks. However, OOB pairing commonly requires the exchange of a temporary key (TK) via a non-BLE channel, such as a near-field communication (NFC) channel. Some devices with BLE communication capabilities may not be configured for NFC communication. This is particularly true for various peripheral devices having minimal space constraints. In many cases, despite their compact sizes, small devices such as wearables may transmit very sensitive user biometric data. Accordingly, a simple yet secure channel that does not rely on BLE communication during pairing would be beneficial.

The present disclosure is generally directed to systems and methods for pairing devices using color change patterns instead of communications via BLE or NFC. Accordingly, the disclosed systems and methods may prevent interception and exploitation of the communications during the device pairing phase. Once the devices are paired, subsequent communications may be securely conducted between the paired devices via standard BLE channels. In some examples, colored lights, such as light-emitting diodes (LEDs), may be used by one device to transmit a pattern and/or sequence for purposes of pairing with another device that is located in relatively close proximity. The other device targeted for pairing may include one or more sensors (e.g., a camera, etc.) that are capable of detecting the light pattern and extracting data based on the pattern and sequence of lights. The transmitted light pattern may thus constitute an OOB channel that does not rely on BLE or NFC protocols. In some examples, if there are multiple devices within BLE range, the light pattern may be used to selectively engage with a desired partner device. The systems and methods disclosed herein may thus improve privacy and security by not broadcasting user identifiable information over standard wireless communication channels.

Features from any of the embodiments described herein may be used in combination with one another in accordance with the general principles described herein. These and other embodiments, features, and advantages will be more fully understood upon reading the following detailed description in conjunction with the accompanying drawings and claims.

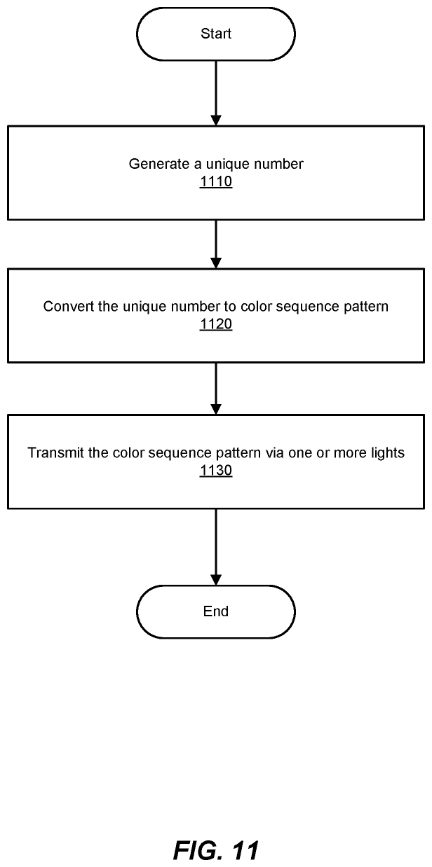

The following will provide, with reference to FIGS. 4A-5C and FIG. 10, systems for wirelessly pairing devices using color change patterns. Additionally, with reference to FIG. 11, the following will provide a method for wirelessly pairing devices using color change patterns.

As mentioned earlier, FIGS. 4A and 4B illustrate an exemplary human-machine interface (also referred to herein as an EMG control interface) configured to be worn around a user's lower arm or wrist as a wearable system 400. Wearable system 400 may also include a light array including one or more lights 440. For example, a plurality of lights may be located on or within wearable system 400 such that they transmit light externally. Lights 440 may each include any suitable type of light emitting element configured to emit light of one or more colors. For example, lights 440 may include LEDs, organic light-emitting diodes (OLEDs), and/or any other suitable type of light-emitting element. In one example, lights 440 may include multiple light colors, such as red, green, and blue (RGB) LEDs. The plurality of light colors may include various visible and/or non-visible wavelengths of light, including wavelengths of light in the visible spectrum (e.g., between approximately 380-700 nm) and/or wavelengths in the infrared light spectrum (e.g., greater than approximately 700 nm). As described in greater detail below, lights 440 may be used to transmit light signals and patterns for pairing wearable system 400 with another partner device.

FIGS. 5A and 5C illustrate an exemplary schematic diagram with internal components of a wearable system with EMG sensors. As shown, the wearable system may include a wearable device 510 (FIG. 5A) and a partner device 570 (FIG. 5C) in communication with the wearable device 510 (e.g., via BLE or another suitable wireless communication technology). As shown in FIG. 5A, the wearable device 510 may include skin contact electrodes 511, examples of which are described in connection with FIGS. 4A and 4B. The output of the skin contact electrodes 511 may be provided to analog front end 530, which may be configured to perform analog processing (e.g., amplification, noise reduction, filtering, etc.) on the recorded signals. The processed analog signals may then be provided to analog-to-digital converter 532, which may convert the analog signals to digital signals that can be processed by one or more computer processors. An example of a computer processor that may be used in accordance with some embodiments is MCU 534, illustrated in FIG. 5A. As shown, MCU 534 may also include inputs from other sensors (e.g., IMU sensor 540), and power and battery module 542.

The output of the processing performed by MCU 534 may be provided to antenna 550 for transmission to partner device 570 shown in FIG. 5C. Additionally, MCU 534 may control a light array 560, which includes one or more lights (e.g., lights 440 in FIG. 4A) that are configured to emit multiple colors. MCU 534 may, for example, direct light array 560 to emit a specified pattern and sequence of lights, which may be detected by external device sensors (e.g., camera 564 of partner device 570).

As shown in FIG. 5C, partner device 570 may include any suitable device (e.g., a smartphone, smart watch, tablet, personal computer, etc.) configured to communicate wirelessly with wearable device 510. Partner device 570 may include an antenna 555, which may be configured to communicate with antenna 550 of wearable device 510. Communication between antennas 550 and 555 may occur using any suitable wireless technology and protocol, non-limiting examples of which include radiofrequency signaling and BLE. As shown, the signals received by antenna 555 of partner device 570 may be provided to a CPU 562 (which may include a BLE or other suitable radio) for further processing, display, and/or for effecting control of a particular physical or virtual object or objects.

Partner device 570 may additionally include a camera 564 or other light sensor that captures light data from the environment. Camera 564 may be capable of receiving light signals transmitted from light array 560 of wearable device 510 for purposes of pairing wearable device 510 and partner device 570 prior to establishing wireless communication (e.g., BLE communication) between the devices. Camera 564 may be in communication with CPU 562 as shown. While camera 564 is shown in FIG. 5C, partner device 570 may alternatively include only a simple light sensor that is able to detect a series of different light colors emitted by light array 560 (the sensor may only need to detect a single color at any one time). However, the more color the camera is capable of detecting, the more bits of data can be represented by a color change pattern and sequence.

Pairing between wearable device 510 and partner device 570 may involve sending and receiving a sequential pattern of colored light (e.g., RGB) signals. Wearable device 510 may function as either a central device or a peripheral device, and the pairing procedure may differ accordingly. When wearable device 510 starts a discovery stage prior to pairing, it may generate a one-time random number. MCU 534 may direct light array 560 to play a sequence that encodes the one-time random number such that lights are emitted by light array 560 in accordance with the specified sequence. Partner device 570 may use camera 564 to capture the light sequence pattern emitted by light array 560. CPU 562 of partner device 570 may then decode the random number encoded by the light sequence pattern.

The subsequent actions performed by wearable device 510 and partner device 570 may differ depending on whether wearable device 510 functions as a central or peripheral component. In some embodiments, wearable device 510 may act as a central component. In this case, partner device 570 may broadcast the random number as part of a BLE advertisement packet via antenna 555. Wearable device 510 may then detect and receive the BLE advertisement packet. If wearable device 510 determines that the payload is the random number, it may then initialize a BLE connection, with wearable device 510 acting as a central device to partner device 570. At this stage, wearable device 510 may change the light sequence pattern to “pairing.” Wearable device 510 may then connect to partner device 570 and each side may save the pairing information as BLE spec.

In various embodiments, wearable device 510 may act as a peripheral, rather than central, component. In such cases, wearable device 510 may broadcast the random number as part of a BLE advertisement packet. Partner device 570 may hear the BLE advertisement packet and determine the payload is the random number. It may then initialize a BLE connection, with partner device 570 central to wearable device 510, which acts as a peripheral device. At this stage, wearable device 510 may change the light sequence pattern to “pairing.” Partner device 570 may then connect to wearable device 510 and each side may save the pairing information as BLE spec.

Following pairing, users can subsequently do a reset, which erases the pairing information. This can bring wearable device 510 back to the discovery stage and wearable device 510 may use a new random number.

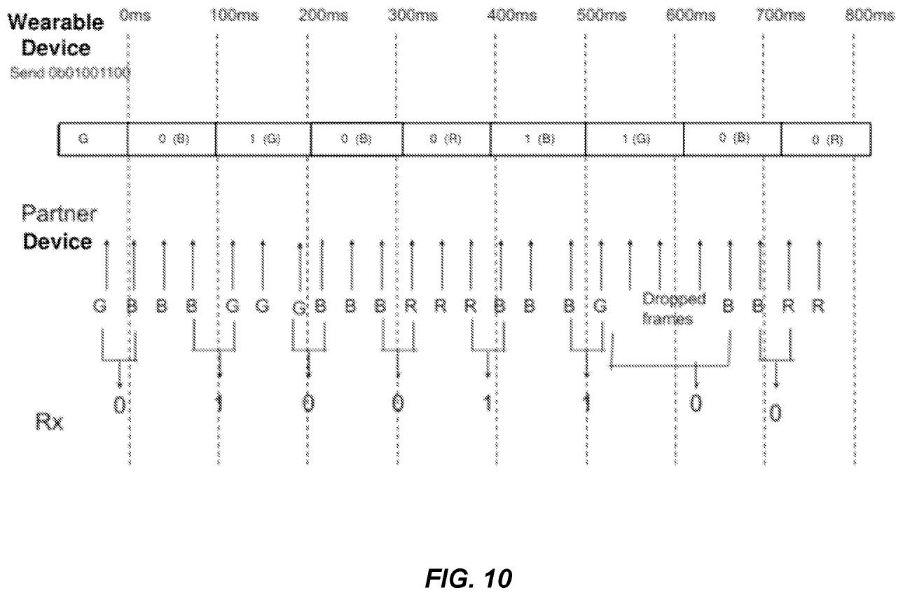

FIG. 10 shows a graph illustrating an example of a wearable device sending a random number coded as a light sequence pattern, which is decoded by a partner device. In this example, random number 0b01001100 is used and the light pattern may be readily received and decoded by a partner device, even without perfect timing alignment. For example, the light sequence pattern emitted by the wearable device may change its color at 10 Hz, while a camera of the partner device may work at 30 Hz. Assuming a light emitted by the wearable device is green at 0 ms; the first bit is 0, so it changes to blue at around 10 ms. The second bit is 1 and with the current color as blue, so it changes to green. And so on. Note that as long as the camera does not miss a color change window, the decoding may work reliably even with the camera dropping frames and/or uneven periods of light emission or camera reception. In some examples, a cyclic redundancy check (CRC) and/or other error checking and correction technique may be used at the end to ensure data integrity. Binary encoding and decoding may be used according to some examples. Additionally, or alternatively, non-binary systems may be utilized for purposes of encoding and decoding, depending, for example, on the number of colors available and/or utilized in the light source(s) (e.g., ternary encoding/decoding may be used for RGB light sources)

A camera of the partner device may not be able to reliably detect light sequence patterns in all environments. For example, the camera might not be able to suitably detect light if the wearable device is far away from the camera or ambient light is too strong. Mitigation may involve asking the user to move the camera into a more suitable position. For example, a display on the partner device can show a circle and ask the user to move the LED to fill the circle. Additionally, or alternatively, an eye tracking feature of the partner device may be used to locate lights emitted by the wearable device.

In some embodiments, a starting pattern (such as R->G->B->R->G->B) may be added to indicate the start. This pattern may also be used to calibrate brightness and color offset for the camera. Color changing may be used to encode bits of data. Color changing may be more robust than color coding because the timing of the light sequence pattern can be asynchronous to the camera. If the camera is 30 FPS, and the change is less than 15 Hz (for example, 10 Hz/10 bit per second), the camera may not miss any change. Each bit may correspond to one color change. Table 1 below shows an example of new colors derived from the current color and bit value for purposes of encoding. Table 2 shows decoded bit values based on the current and next colors in a received sequence pattern, which was encoded in accordance with Table 1.

TABLE 1
Encoding key including colors and bit values

| Current Color → | Red | Green | Blue |
|---|---|---|---|
| Next Bit = 0 | Green | Blue | Red |
| Next Bit = 1 | Blue | Red | Green |

TABLE 2
Decoding key including colors and bit values

| Current Color → | Red | Green | Blue |
|---|---|---|---|
| Next Color = Red | No data | 1 | 0 |
| Next Color = Green | 0 | No data | 1 |
| Next Color = Red | 1 | 0 | No data |

FIG. 11 is a flow diagram of an exemplary method 1100 for pairing devices that includes encoding a color change pattern. At least some of the steps shown in FIG. 11 may be performed by any suitable computer-executable code, computing system, and/or device, including the system(s) illustrated in FIGS. 4A-5C.

As illustrated in FIG. 11, at step 1110, one or more of the systems described herein may generate a unique number. For example, MCU 534 of wearable device 510 may generate a random number sequence to be used for purposes of pairing wearable device 510 with another device, such as partner device 570 (see, e.g., FIGS. 5A and 5C).

At step 1120, one or more of the systems described herein may convert the unique number to a color sequence pattern. For example, a wearable device 510 may generate a one-time random number and then convert the random number into a corresponding color sequence pattern (see, e.g., FIG. 5A). The number may be converted to the color sequence pattern in any suitable manner. For example, the number may be encoded to produce a color sequence pattern using a suitable encoding key, such as that shown in Table 1.

At step 1130, one or more of the systems described herein may transmit the color sequence pattern via one or more lights. For example, wearable device 510 may transmit the encoded color sequence pattern via one or more lights in light array 560, which may be capable of emitting a plurality of colors (e.g., RGB) (see, e.g., FIG. 5A).

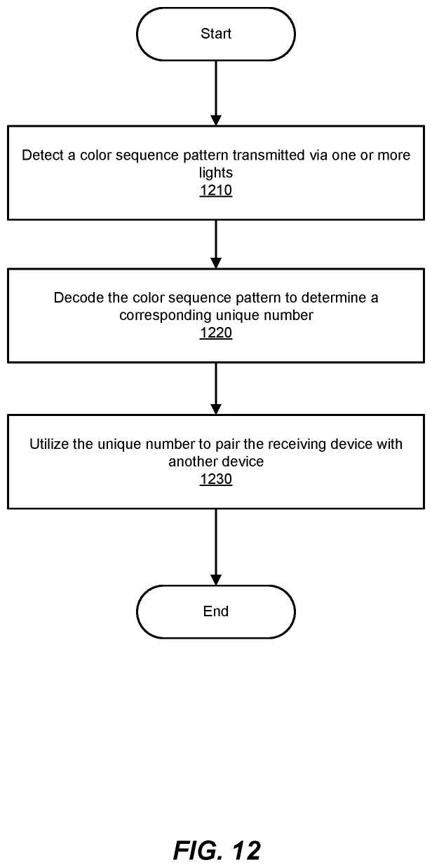

FIG. 12 is a flow diagram of an exemplary method 1200 for pairing devices that includes decoding a color change pattern. At least some of the steps shown in FIG. 12 may be performed by any suitable computer-executable code, computing system, and/or device, including the system(s) illustrated in FIGS. 4A-5C.

As illustrated in FIG. 12, at step 1210, one or more of the systems described herein may detect, at a receiving device, a color sequence pattern transmitted via one or more lights. For example, camera 564 of partner device 570 may receive a color sequence pattern transmitted from light array 560 of wearable device 510.

At step 1220, one or more of the systems described herein may decode the color sequence pattern to determine a corresponding unique number. For example, a decoding key, such as that shown in Table 2, may be utilized by CPU 262 of partner device 570 to decode the color sequence pattern to determine a corresponding unique number (see, e.g., FIG. 5C). The unique number may, for example, be a random number sequence that was previously encoded by wearable device 510 for purposes of pairing.

At step 1230, one or more of the systems described herein may utilize the unique number to pair the receiving device with another device. For example, the unique number may be used to pair partner device 570 with wearable device 510.

The unique number may be used to pair the devices in any suitable manner. For example, wearable device 510 may act as a central component and partner device 570 may broadcast the random number as part of BLE advertisement packet via antenna 555. Wearable device 510 may hear the BLE advertisement packet and initialize a BLE connection with partner device 570.

In some examples, wearable device 510 may act as a peripheral component and may broadcast the unique number as part of a BLE advertisement packet. Partner device 570 may hear the BLE advertisement packet and determine the payload is the unique number. Partner device 570 may then initialize a BLE connection with wearable device 510.

The disclosed systems and methods may thus use color change patterns instead of communications via BLE or NFC to initiate wireless pairing of devices. Accordingly, the disclosed systems and methods may prevent interception and exploitation of the communications during the device pairing phase, protecting against third party attacks such as man-in-the-middle attacks. Transmitted light sequence patterns may constitute an OOB channel that does not rely on BLE or NFC protocols. Thus, privacy may be improved by not explicitly broadcasting identifiable information via more conventional channels during the pairing phase. In some examples, if multiple devices are within BLE range, a light pattern may be used to selectively engage with a desired partner device. The systems and methods disclosed herein may thus improve privacy and security by not broadcasting user identifiable information over standard wireless communication channels.

Although the examples provided with reference to FIGS. 4A-4B and FIGS. 5A-5C are discussed in the context of interfaces with EMG sensors, techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors. The techniques described herein for reducing electromagnetic interference can also be implemented in wearable interfaces that communicate with computer hosts through wires and cables (e.g., USB cables, optical fiber cables, etc.).

Mutual Capacitance Bend Sensor

The present disclosure is generally directed to an assembly for improving the detection of movement in AR/VR wearables by integrating two wires into an interior surface of a wearable and detecting changes in mutual capacitance between these wires. For example, transmit and receive wires may be positioned on a palmar side of glove's finger, and a controller may determine that a change in mutual capacitance between these wires is indicative of movement (i.e., bending or unbending). In this manner, such an assembly may aid hand pose estimation and may improve movement detection in a variety of other types of devices. Features from any of the embodiments described herein may be used in combination with one another in accordance with the general principles described herein. These and other embodiments, features, and advantages will be more fully understood upon reading the following detailed description in conjunction with the accompanying drawings and claims.

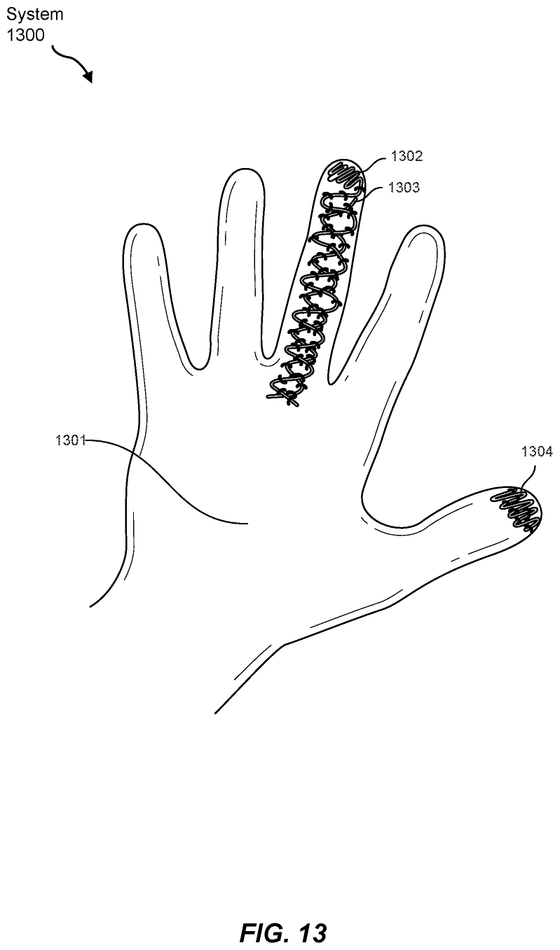

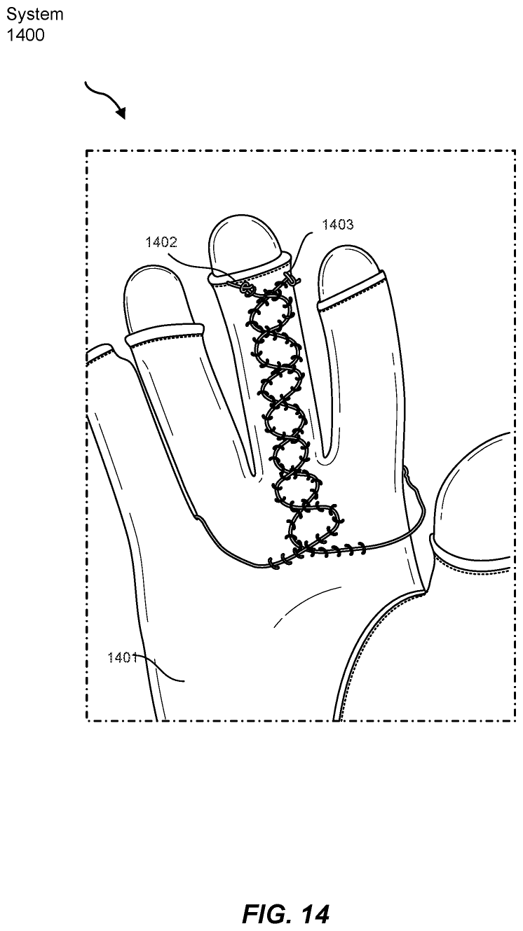

The following will provide, with reference to FIGS. 13-14, detailed descriptions of an assembly for improving the detection of movement in AR/VR wearables: the discussion associated with FIG. 13 relates to an example an assembly for improving the detection of movement in AR/VR wearables, and the discussion associated with FIG. 14 relates to the surface of a AR/VR wearable device that may be implemented in accordance with certain AR/VR devices.

Turning to FIG. 13, system 1300 may include a wearable device with a surface 1301 configured to integrate a transmit wire 1302 and a receive wire 1303. According to some embodiments, surface 1301 may be dimensioned to fit over an interior side of a hinge joint (e.g., a finger knuckle, elbow, knee, etc.) of a wearer. Thus, surface 1301 may be a palmar side of a glove, an interior side of a sleeve or arm brace, and/or a back side of a pant leg or knee brace. Surface 1301 may also be another interior surface that would typically be positioned at or near a joint when worn by a user.

As shown, transmit and receive wires 1302 and 1303 may be integrated into and extend along an interior surface 1301 of a wearable system. Transmit and receive wires 1302 and 1303 may be configured in any suitable pattern. For example, in some embodiments, transmit wire 1302 and receive wire 1303 may be arranged in serpentine patterns with each wire being a mirror image of the other. A microcontroller (or any other suitable computing device) coupled to transmit and receive wires 1302 and 1303 may determine that a change in mutual capacitance between transmit wire 1302 and receive wire 1303 is indicative of movement (i.e., pinching, bending, or unbending). In some embodiments, a receive wire 1304 may be placed on the thumb region of system 1300 and/or on multiple fingers of system 1300. In the example shown in FIG. 13, a change in mutual capacitance between receive wire 1304 and transmit wire 1302 may be indicative of a pinching motion between a user's thumb and middle finger.

To measure mutual capacitance, the microcontroller may transmit a drive signal (e.g., a series of pulses) over transmitter wire 1302. According to some embodiments, the microcontroller may use a measurement circuit to measure the signal that is generated on the receive wire 1303 from capacitive coupling with the transmit wire 1302. This mutual capacitance measurement is referred to here as a bend measurement, which system 1300 may use to aid hand pose estimation and to improve movement detection in a variety of other types of devices. In some embodiments, higher bend measurements may indicate that a finger or joint is bent, while lower bend measurements may indicate that the finger or other joint is straight.

FIG. 14 shows another example of a wearable system 1400 with a transmit wire 1402 and a receive wire 1403 integrated into a surface 1401. As a user bends their middle finger, surface 1401 shortens. When surface 1401 shortens, transmit wire 1402 and receive wire 1403 may compress into wire loops and may force the wire crossings to flatten, similar to the motion of a scissor jack. In other words, as a user bends their finger the outer sections of the loops fold down on top of each other which increases the capacitive coupling between transmit wire 1402 and receive wire 1403. According to some embodiments, it may be preferable for the transmit wire 1402 and receive wire 1403 to be stiffer than the substrate of system 1400 to enhance this motion. As noted above, compression of the wire loops may change the mutual capacitance between the transmit and receive wires, and the change in mutual capacitance may be detected as an indicator of a change in hand pose.

The transmit and receive wires discussed herein may be made of any suitable material and configured in any suitable manner. According to some embodiments, the transmit and receive wires may be conductors (e.g., copper, spring steel, carbon impregnated silicone, etc.) encased in an insulator. The transmit and receive wires may also be patterned and crossed in any suitable way such than bending causes a flattening of the distance (and corresponding mutual capacitance increase) between the transmit wire and receive wire. According to some embodiments, transmit and receive wires may be embroidered onto a surface. Alternatively, the wires may be knit onto a surface or attached to a surface in any other suitable manner.

As noted above, a microcontroller can detect touch between a transmit wire and a receive wire to sense a finger pinch gesture. According to some embodiments, when this touch is detected, the microcontroller can store the bend measurement as a calibration value, and the microcontroller can compare future bend measurements against this calibration value. The systems disclosed herein may also be calibrated to detect pinch or bend gestures in any other suitable manner.

Technical Solutions to Enhance Social Acceptability

With the rise in popularity of augmented-reality (AR) systems such as AR glasses that may be always on and able to capture or record information from their environments, more and more people are becoming concerned with the intrusiveness and privacy of these types of systems, especially for bystanders. Although such concerns may be something that society will eventually figure out (e.g., via agreed upon social norms and social etiquette), other mechanisms that ensure people's privacy may be needed, such as privacy policies and related technologies.

The present disclosure is generally directed to various technology innovations that aim to improve (1) bystanders' control of how and when AR systems capture or record information about the bystanders, (2) how AR systems benefit bystanders, and (3) bystanders' understanding of the functions and capabilities of AR systems including when and what the AR systems may be capturing or recording. As will be explained in greater detail below, in some embodiments, the disclosed solutions may be performed on a device and/or in the cloud. In some embodiments, the disclosed solutions may be hardware-based and/or software-based and may include algorithms and/or user interfaces.

Features from any of the embodiments described herein may be used in combination with one another in accordance with the general principles described herein. These and other embodiments, features, and advantages will be more fully understood upon reading the following detailed description in conjunction with the accompanying drawings and claims.

In some embodiments, the disclosed systems and methods may enable an owner or user of an AR system to control what information is or is not captured or recorded from their environment. For example, the disclosed systems and methods may enable an owner or user of an AR system to choose a privacy policy or filter in a control menu for the AR system (or in a companion application on another system) that causes the AR system to blur, obscure, or alter faces, bodies, letters, or numbers in captured or recorded data such as video data. In some embodiments, the disclosed systems may enable an owner or user of an AR system to choose to capture or record data only when they have ownership of their environment or only when they are in a public space that allows such capturing or recording.

In some embodiments, the disclosed systems may enable privacy policies or filters to be contextualized. For example, the disclosed systems and methods may enable an owner or a user of an AR system to set different privacy policies or filters for different locations, users, situations, etc. For example, the disclosed systems may enable a user to select to obscure information related to bystanders outside of a predefined group (e.g., household members, family members, friends, or co-workers). In some embodiments, the disclosed systems may detect contextual changes and may suggest default privacy policies or filters within different contexts. In some embodiments, the disclosed systems may enable owners or users to manually change the settings of privacy policies or filters when they need to as well.

In some embodiments, the disclosed systems and methods may support sharing information about a capture or recording to bystanders. For example, the disclosed systems and methods may enable an owner or user of an AR system to share a live preview of captured data with bystanders. In some embodiments, the disclosed systems and methods may send the live preview from the AR system to a companion application running on another device (e.g., a smartphone or smartwatch) so that the bystanders can see how privacy is being protected prior to capture or recording.

For bystanders who may be captured or recorded, the disclosed systems may perform a variety of actions or functions. In some embodiments, the disclosed systems and methods may enable bystanders to have more control in determining whether they or information associated with them are captured or recorded by users of AR systems. For example, the disclosed systems and methods may enable bystanders to hold a visual pattern (e.g., a QR code) in front of an AR system's camera to filter recently captured photos/videos and/or to blur faces that match with the bystander or the bystanders' companions. Additionally, or alternatively, the disclosed systems and methods may provide bystanders with an opt-in or opt-out mechanism through an application running on the bystanders' phones. In some embodiments, the disclosed systems and methods may detect when a bystander who has opted out of capture or recording and may not capture or record the bystander or at all when near the bystander.

The disclosed systems may perform some or all the disclosed methods in the cloud. For example, by default, the disclosed systems may blur faces in captured images or videos unless the person who is in the captured images or video has given permission to the system not to do so. For a person that wants to be captured by a specific AR system (or a category of these capturing systems), the disclosed systems may enable the person to grant permission through some kind of interface (e.g., using a face-identification system). If permissions are tied to a particular face identity (or something similar with encrypted information about the person's facial features), then the disclosed systems may guarantee that the identity of the one in the capture is the same as the one who grants permission.

In some embodiments, the disclosed systems and methods may enable owner or users of an AR system or bystanders to choose different granularities of permission control (e.g. permission per capture, permission per glass wearer, permission to public, etc.). In at least some environments, the disclosed systems may not obscure faces of bystanders in images or videos by default unless the bystanders request that they be obscured. In some embodiments, the disclosed systems may implement the disclosed permission granting systems using a suitable blockchain technology (e.g., one that is decentralized, encrypted, and/or shared across the network to foster trust in the permission system).

In some embodiments, the disclosed systems may determine what and when to obscure information contained in a data capture based on bystanders' proximity to a capturing device. In at least one embodiment, the disclosed systems may use Bluetooth, NFC, or any other suitable short-range wireless communication technology to detect bystanders' devices and/or discover bystanders' preferred privacy settings. In some embodiments, the disclosed systems may detect bystanders' devices and/or bystanders' preferred privacy settings based on location information (e.g., a geolocation, real-world location, or environment location). For example, the disclosed systems may monitor the location of a capturing device and may convey privacy information related to bystanders at the same location. In at least one embodiment, the disclosed systems may notify bystander devices when data captures start or end, privacy information related to the data captures, and/or changes to privacy information during data captures and enable bystanders to choose or update their desired privacy settings related to the data captures.

In at least some embodiments, the disclosed systems may discover and/or apply bystander privacy settings in a way that is transparent to bystanders and/or users of capturing devices. For example, the disclosed systems may enable a capturing device to capture data from an environment containing one or more bystanders in a way that upholds the bystanders' preferred privacy settings by transparently identifying bystanders and/or their preferred privacy settings and transparently applying those settings to the captured data at the capturing device (or another device with access to the data). In at least one embodiment, the disclosed systems may block a capturing device from capturing certain types of data from an environment when bystanders' preferred privacy settings disallow it. In some embodiments, the disclosed systems may block a capturing device from capturing data that includes a bystander from an environment when the bystander's preferred privacy settings disallow it.

The disclosed systems may improve or eliminate issues related to a bystanders' lack of understanding of data capture using a variety of techniques and methods. These techniques and methods may be used as an alternative to or in addition to a light indicating an ongoing capture, especially in situations where such light indicators may not be obvious enough for bystanders. In some embodiments, the disclosed systems may express an ongoing capture using modalities other than light such as voice output or a companion app accessible to bystanders that shows messages that are easily readable. In at least one embodiment, the disclosed systems may be configured to respond to inquiries from bystanders such as “Are you recording?” with information indicating whether a recording is ongoing or not and/or what privacy setting the recording is applying.

In some embodiments, when a user of a mobile computing device has applied a certain privacy filter for a capture, the disclosed systems may provide information about the privacy filter to users using a variety of techniques or methods. In one embodiment, the disclosed systems may convey privacy information to bystanders by encoding the privacy into light patterns that may be detected by the bystanders and/or their devices. In some embodiments, when the light is indicating a capture, the light's cadence may encode a privacy setting, and a bystander could read this pattern through a mobile device camera, which may provide the bystander with verification for the privacy setting that the wearer had. In some embodiments, the disclosed systems may use high-frequency patterns to convey privacy information. In some circumstances, the high-frequency patterns may be imperceptible to users but perceptible to their devices.

In some embodiments, the disclosed systems may convey privacy information to bystanders based on the bystanders' proximity to a capturing device. In at least one embodiment, the disclosed systems may use Bluetooth, NFC, or any other suitable short-range wireless communication technology to convey and/or broadcast privacy information to bystanders' devices. In some embodiments, the disclosed systems may communicate and/or track data captures and their associated privacy information based on location information (e.g., a geolocation, real-world location, or environment location). In one example, a location (e.g., a country, a state, a city, a public space, a place of business, a residence, or any subcomponent thereof) may have an associated default privacy policy that may be applied when data is captured in the location, and the disclosed systems may communicate these default privacy policies to users (including bystanders) when the users are at the locations. In some embodiments, the disclosed systems may enable bystanders to personalize their preferred privacy levels to be more or less private than the default in any given location.

In another example, the disclosed systems may monitor the location of a capturing device and may convey privacy information related to data captures to any other bystander devices at the same location. In at least one embodiment, the disclosed systems may notify bystander devices when data captures start or end, privacy information related to the data captures, and/or changes to privacy information during data captures. In at least one embodiment, the disclosed systems may enable bystanders to be notified when privacy settings related to data captures in their vicinity do not conform to a desired level of privacy.

As explained above, the disclosed systems and methods provide multiple distinct technical solutions that would help in the widespread adoption of AR glasses and other devices capable of recording. These solutions should reduce people's hang-ups with recording devices by taking steps both on the device side (i.e., the AR glasses' side) and on the bystander side.

The disclosed systems and methods may provide a variety of device-side privacy protections. In some embodiments, the disclosed systems and methods may use artificial intelligence to identify locations, events, specific groups of people, or environments. Then, based on the artificial intelligence, the disclosed systems may turn off specific sensors or modify how the sensors are operating. Examples of sensors may include, without limitation, cameras, inertial measurement units (IMUS), microphones, or data storage. In some embodiments, the disclosed systems and methods may auto-change privacy settings when artificial intelligence detects a new environment or when GPS indicates a new location.

In some embodiments, the disclosed systems and methods may auto-blur faces and/or sensitive objects prior to storing data. In some embodiments, the disclosed systems and methods may detect and apply location-based policies. For example, the disclosed systems may implement recording and no-recording policies/restrictions in private spaces (e.g., businesses or residences).

In some embodiments, the disclosed systems and methods may detect and/or apply policies for specific bystanders. For example, the disclosed systems may receive and comply with indications from bystanders that they don't want to be recorded. In some embodiments, the disclosed systems and methods may present a live preview on a separate device of what is being recorded by the recording device.

The disclosed systems and methods may provide a variety of bystander-side privacy protections. In some embodiments, the disclosed systems and methods may enable a bystander's device to read encoded light emissions from AR glasses that are encoded with the glasses' privacy settings, which may allow the bystander to see (on their device) the privacy settings of the AR glasses.

In some embodiments, the disclosed systems and methods may enable a bystander's device to passively indicate to other devices in proximity a desire not to be captured or recorded. For example, the disclosed systems may utilize NFC/Bluetooth proximity-based indications sent to AR glasses or QR codes that are shown on the bystander's device and “seen” by AR glasses. In some embodiments, the disclosed systems and methods may enable a bystander's device to send a direct opt in or opt out message to a capturing or recording device such as AR glasses. In some embodiments, the disclosed systems and methods may enable bystanders to perform a gesture (e.g., on a smartwatch) to send an opt in or opt out message.

In some aspects, the techniques described herein relate to a computer-implemented method including: detecting a bystander within range of a sensor of a mobile computing device; determining, based on one or more privacy policies associated with the bystander or the mobile computing device, whether capturing of information associated with the bystander using the sensor is authorized; when capturing of information associated with the bystander is authorized, capturing information associated with the bystander; and when capturing of information associated with the bystander is not authorized, refraining from capturing the information associated with the bystander.

In some aspects, the techniques described herein relate to a method, wherein: the mobile computing device is a pair of augmented-reality glasses; and the sensor is one of a video sensor, an image sensor, or a microphone.

In some aspects, the techniques described herein relate to a method, further including transmitting to an additional mobile computing device of the bystander an indication of the one or more privacy policies.

In some aspects, the techniques described herein relate to a method, further including: detecting a desire of the bystander to understand the one or more privacy policies; and emitting, in response to the desire, an auditory indication of the one or more privacy policies.

In some aspects, the techniques described herein relate to a method, further including: detecting a desire of the bystander to understand whether the mobile computing device is capturing information associated with the bystander; and emitting, in response to the desire, an auditory indication of whether the mobile computing device is capturing information associated with the bystander.

In some aspects, the techniques described herein relate to a method, wherein the one or more privacy policies include a privacy policy associated with and maintained by the bystander.

In some aspects, the techniques described herein relate to a method, wherein the one or more privacy policies include a privacy policy associated with the mobile computing device and maintained by a user of the computing device.

In some aspects, the techniques described herein relate to a method, wherein the one or more privacy policies include a privacy policy associated with a location in which the mobile computing device and the bystander are present.

In some aspects, the techniques described herein relate to a method, wherein the one or more privacy policies are maintained by an owner or administrator of the location.

In some aspects, the techniques described herein relate to a computer-implemented method including: detecting a bystander within range of a sensor of a mobile computing device; determining, based on one or more privacy policies associated with the bystander or the mobile computing device, whether recording of information associated with the bystander and captured using the sensor is authorized; capturing information associated with the bystander; when recording of information associated with the bystander is authorized, recording the captured information associated with the bystander; and when recording of information associated with the bystander is not authorized, refraining from recording the captured information associated with the bystander.

In some aspects, the techniques described herein relate to a method, wherein: the mobile computing device is a pair of augmented-reality glasses; and the sensor is one of a video sensor, an image sensor, or a microphone.

In some aspects, the techniques described herein relate to a method, wherein: capturing the information associated with the bystander includes capturing a video of an environment of the pair of augmented-reality glasses, the video including the information associated with the bystander; and refraining from recording the captured information associated with the bystander includes obscuring the captured information associated with the bystander within the video before recording the video.

In some aspects, the techniques described herein relate to a method, wherein the captured information associated with the bystander is obscured within the video by the pair of augmented-reality glasses.

In some aspects, the techniques described herein relate to a method, wherein the captured information associated with the bystander is obscured within the video by a remote storage device to which the pair of augmented-reality glasses transmitted the video for storage.

In some embodiments, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other users of the online social network.

Similarly, the privacy settings applied to a particular node may control whether the user or concept corresponding to the node is visible to other users of the online social network. As an example, and not by way of limitation, a first user may share an object to the social-networking system. The object may be associated with a concept node connected to a user node of the first user by an edge. The first user may specify privacy settings that apply to a particular edge connecting to the concept node of the object or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In some embodiments, a social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In some embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

In some embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In some embodiments, an object may represent content that is visible to a user through a newsfeed of the user. As an example, and not by way of limitation, one or more objects may be visible to a user's “Trending” page. In some embodiments, an object may correspond to a particular user. The object may be content associated with the particular user or may be the particular user's account or information stored on the social-networking system or other computing system. As an example, and not by way of limitation, a first user may view one or more second users of an online social network through a “People You May Know” function of the online social network, or by viewing a list of friends of the first user. As an example, and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In some embodiments, different objects of the same type associated with a user may have different privacy settings. Different types of objects associated with a user may have different types of privacy settings. As an example, and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In some embodiments, different privacy settings may be provided for different user groups or user demographics. As an example, and not by way of limitation, a first user may specify that other users who attend the same university as the first user may view the first user's pictures, but that other users who are family members of the first user may not view those same pictures.

In some embodiments, the social-networking system may provide one or more default privacy settings for each object of a particular object-type. A privacy setting for an object that is set to a default may be changed by a user associated with that object. As an example, and not by way of limitation, all images posted by a first user may have a default privacy setting of being visible only to friends of the first user and, for a particular image, the first user may change the privacy setting for the image to be visible to friends and friends-of-friends.

In some embodiments, privacy settings may allow a first user to specify (e.g., by opting out, by not opting in) whether the social-networking system may receive, collect, log, or store particular objects or information associated with the user for any purpose. In some embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example, and not by way of limitation, a first user may transmit a message to a second user via an application related to the online social network (e.g., a messaging app), and may specify privacy settings that such messages should not be stored by the social-networking system.

In some embodiments, a user may specify whether particular types of objects or information associated with the first user may be accessed, stored, or used by the social-networking system. As an example, and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In some embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

Privacy Settings for Ephemeral Sharing

In some embodiments, privacy settings may allow a user to engage in the ephemeral sharing of objects on an online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In some embodiments, for particular objects or information having privacy settings specifying that they are ephemeral, the social-networking system may be restricted in its access, storage, or use of the objects or information. The social-networking system may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the social-networking system may temporarily store the message in a data store until the second user has viewed or downloaded the message, at which point the social-networking system may delete the message from the data store. As another example and not by way of limitation, continuing with the prior example, the message may be stored for a specified period of time (e.g., 2 weeks), after which point the social-networking system may delete the message from the data store.

Privacy Settings Based on Location

In some embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

Privacy Settings for User-Authentication and Experience-Personalization Information

In some embodiments, a social-networking system may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system. The user's privacy settings may specify that such information may be used only for particular processes, such as authentication, and further specify that such information may not be shared with any third-party system or used for other processes or applications associated with the social-networking system. As another example and not by way of limitation, the social-networking system may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system or used by other processes or applications associated with the social-networking system. As another example and not by way of limitation, the social-networking system may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any third-party system or used by other processes or applications associated with the social-networking system.

User-Initiated Changes to Privacy Settings

In some embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. A social-networking system may determine that this privacy setting also applies to the first image and make the first image visible only to the first user group. In some embodiments, the change in privacy settings may take effect only going forward. Continuing the example above, if the first user changes privacy settings and then shares a second image, the second image may be visible only to the first user group, but the first image may remain visible to all users. In some embodiments, in response to a user action to change a privacy setting, the social-networking system may further prompt the user to indicate whether the user wants to apply the changes to the privacy setting retroactively. In some embodiments, a user change to privacy settings may be a one-off change specific to one object. In some embodiments, a user change to privacy may be a global change for all objects associated with the user.

In some embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In some embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In some embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In some embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In some embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

Privacy Settings for Mood, Emotion, or Sentiment Information

In some embodiments, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. For example, a social-networking system may predict or determine a mood, emotion, or sentiment associated with a user based on, for example, inputs provided by the user and interactions with particular objects, such as pages or content viewed by the user, posts or other content uploaded by the user, and interactions with other content of the online social network. In some embodiments, the social-networking system may use a user's previous activities and calculated moods, emotions, or sentiments to determine a present mood, emotion, or sentiment. A user who wishes to enable this functionality may indicate in their privacy settings that they opt in to the social-networking system receiving the inputs necessary to determine the mood, emotion, or sentiment. As an example and not by way of limitation, the social-networking system may determine that a default privacy setting is to not receive any information necessary for determining mood, emotion, or sentiment until there is an express indication from a user that the social-networking system may do so. By contrast, if a user does not opt in to the social-networking system receiving these inputs (or affirmatively opts out of the social-networking system receiving these inputs), the social-networking system may be prevented from receiving, collecting, logging, or storing these inputs or any information associated with these inputs. In some embodiments, the social-networking system may use the predicted mood, emotion, or sentiment to provide recommendations or advertisements to the user. In some embodiments, if a user desires to make use of this function for specific purposes or applications, additional privacy settings may be specified by the user to opt in to using the mood, emotion, or sentiment information for the specific purposes or applications. As an example and not by way of limitation, the social-networking system may use the user's mood, emotion, or sentiment to provide newsfeed items, pages, friends, or advertisements to a user. The user may specify in their privacy settings that the social-networking system may determine the user's mood, emotion, or sentiment. The user may then be asked to provide additional privacy settings to indicate the purposes for which the user's mood, emotion, or sentiment may be used. The user may indicate that the social-networking system may use his or her mood, emotion, or sentiment to provide newsfeed content and recommend pages, but not for recommending friends or advertisements. The social-networking system may then only provide newsfeed content or pages based on user mood, emotion, or sentiment, and may not use that information for any other purpose, even if not expressly prohibited by the privacy settings.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Visibility Based Subscription for Video Calls

Conventional video calls on mobile platforms may have at least two major challenges; namely, (1) limited screen real estate and (2) limited battery and memory. For example, on a call with fifty people, such video calls may fail to show the video streams of all fifty people in a way that is both practical and efficient in terms of resources (e.g., screen real estate, battery, memory, etc.). Some conventional approaches may show video streams of eight of the fifty people. Those eight people may be determined as being the most efficient use of screen space, but it may merely consist of the people who entered the video call first and then rotate in dominant speakers. Such approaches may be inflexible and may fail to give the user a choice to pick who they want to see in their video call. Without this control, the user may lose engagement with the video call since they are essentially being forced who they have to view the whole time. Moreover, this may mean that the user may not have a full sense of who is in the call at all times. By way of non-limiting illustration, during a birthday party video call, a user may want to keep focused on the person with the birthday, but they may never be dominant speaker, or they may keep getting replaced as dominant speaker, which may mean there is no guarantee that the birthday person remains in the users' eight-person grid.

Exemplary implementations disclosed herein may address these and/or other shortcomings. For example, some implementations may give the user control to see everyone in the video call at any time in a way that is efficient in terms of mobile performance and resources (e.g., screen real estate, battery, memory, etc.).

Some implementations may accomplish giving the user an ability to see everyone in the video call by allowing them to scroll as more than eight participants join the video call. Unlike implementing this as separate pages of peer videos, exemplary embodiments may provide the user with a dynamic scroll (e.g., as if scrolling on a webpage). As the user scrolls, new peers may come into frame. In some implementations, a visibility-based subscription method may be used to track which peers are becoming visible and then subscribe to their video stream.

A visibility-based video subscription may include, at any given point in time, determining which peers are visible to the user and which peers are not. This may be done using impression tracking. When a tile in the grid is created for each peer, this view may be registered with the impression tracker, which may facilitate tracking whether their view is visible, what size it is, and how much of it is fully visible even as it moves around the screen. Given this information, the video streams may be subscribed to such that visibility criteria are met. When the user scrolls a peer out of view, the subscription for that peer may be removed (i.e., no longer visible) and a subscription for the new peer that is now visible may be added.

Some implementations may include determining which peers are visible in the call view. Some implementations may include efficiently translating these visibility updates to subscription requests. Impression tracking may include polling the screen for visibility updates (e.g., once every 100 milliseconds (ms)) for every peer that is on the screen with video. In some implementations, one to two seconds of scrolling may generate hundreds of visibility updates. These updates may not all directly translate to server subscription requests. These updates while scrolling may happen close together and may occur in the same runloop pass. For efficiency, some implementations may include a debouncer to coalesce the updates that happen in the same runloop pass into a single visibility update that is forwarded to a call engine. On the engine side, there may be additional throttling to make sure that too many subscription requests are not occurring in a short amount of time.

In some implementations, the visibility tracker may send information regarding how much of the peer is actually visible, and then the call engine may use that information to drop the subscription if desired. For example, a rule may be set so that only peers that are more than 20% visible to the user are subscribed to. Through this approach of visibility subscription and its optimizations, exemplary implementations may achieve an experience that is as dynamic as scrolling on a webpage, while just as efficient as a conventional, fixed eight-people view.

The disclosed system(s) address a problem in traditional video calls techniques tied to computer technology, namely, the technical problem of limited resources on mobile devices including screen real estate, battery life, memory, and/or other resources. The disclosed system solves this technical problem by providing a solution also rooted in computer technology, namely, by providing for a visibility-based subscription for video. The disclosed subject technology further provides improvements to the functioning of the computer itself because it improves processing and efficiency in video calls.

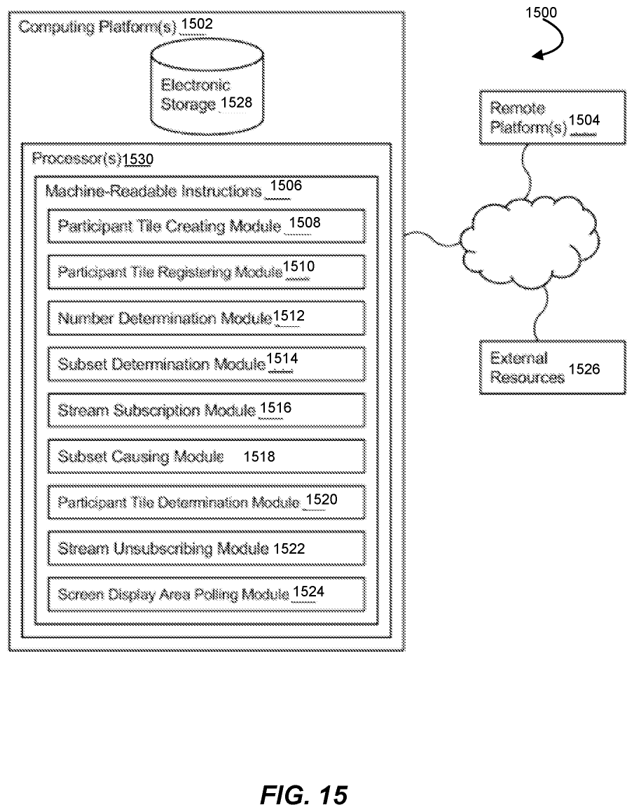

FIG. 15 illustrates a system 1500 configured for a visibility-based subscription for video calls, in accordance with one or more implementations. In some implementations, system 1500 may include one or more computing platforms 1502. Computing platform(s) 1502 may be configured to communicate with one or more remote platforms 1504 according to a client/server architecture, a peer-to-peer architecture, and/or other architectures. Remote platform(s) 1504 may be configured to communicate with other remote platforms via computing platform(s) 1502 and/or according to a client/server architecture, a peer-to-peer architecture, and/or other architectures. Users may access system 1500 via remote platform(s) 1504.

Computing platform(s) 1502 may be configured by machine-readable instructions 1506. Machine-readable instructions 1506 may include one or more instruction modules. The instruction modules may include computer program modules. The instruction modules may include one or more of participant tile creating module 1508, participant tile registering module 1510, number determination module 1512, subset determination module 1514, stream subscription module 1516, subset causing module 1518, participant tile determination module 1520, stream unsubscribing module 1522, screen display area polling module 1524, and/or other instruction modules.

Participant tile creating module 1508 may be configured to create a participant tile for each of a plurality of participants of a video call. Each participant tile may be associated with a video stream of a participant of the plurality of participants.

Participant tile registering module 1510 may be configured to register each participant tile.

Number determination module 1512 may be configured to determine a number of registered participant tiles exceeds a maximum number of registered participant tiles that can be displayed in a device screen display area.

Subset determination module 1514 may be configured to determine a subset of the registered participant tiles that meet at least one visibility criterion. The at least one visibility criterion may include a proportion of an area of a registered participant tile that is visible on the device screen display. Polling the screen for display area updates regarding which registered participant tiles meet the at least one visibility criterion may include polling the screen display area every 100 milliseconds.

Stream subscription module 1516 may be configured to subscribe to the video streams of the participants associated with the subset of registered participant tiles.

Stream subscription module 1516 may be configured to subscribe to the video stream of a participant associated with the new registered participant tile.

Subset causing module 1518 may be configured to cause the subset of registered participant tiles to be displayed in the device screen display area.

Participant tile determination module 1520 may be configured to determine that a registered participant tile of the subset of registered participant tiles no longer meets the at least one visibility criterion.

Participant tile determination module 1520 may be configured to determine that a new registered participant tile meets the at least one visibility criterion.

Stream unsubscribing module 1522 may be configured to unsubscribe from the video stream of the participant associated with the registered participant tile.

Screen display area polling module 1524 may be configured to periodically poll the screen display area for updates regarding which registered participant tiles meet the at least one visibility criterion. Determining the subset of the registered participant tiles that may meet the at least one visibility criterion includes determining the subset of the registered participant tiles using impression tracking.

In some implementations, computing platform(s) 1502, remote platform(s) 1504, and/or external resources 1526 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 1502, remote platform(s) 1504, and/or external resources 1526 may be operatively linked via some other communication media.

A given remote platform 1504 may include one or more processors configured to execute computer program modules. The computer program modules may be configured to enable an expert or user associated with the given remote platform 1504 to interface with system 1500 and/or external resources 1526, and/or provide other functionality attributed herein to remote platform(s) 1504. By way of non-limiting example, a given remote platform 1504 and/or a given computing platform 1502 may include one or more of a server, a desktop computer, a laptop computer, a handheld computer, a tablet computing platform, a NetBook, a Smartphone, a gaming console, and/or other computing platforms.

External resources 1526 may include sources of information outside of system 1500, external entities participating with system 1500, and/or other resources. In some implementations, some or all of the functionality attributed herein to external resources 1526 may be provided by resources included in system 1500.

Computing platform(s) 1502 may include electronic storage 1528, one or more processors 1530, and/or other components. Computing platform(s) 1502 may include communication lines, or ports to enable the exchange of information with a network and/or other computing platforms. Illustration of computing platform(s) 102 in FIG. 15 is not intended to be limiting. Computing platform(s) 1502 may include a plurality of hardware, software, and/or firmware components operating together to provide the functionality attributed herein to computing platform(s) 1502. For example, computing platform(s) 1502 may be implemented by a cloud of computing platforms operating together as computing platform(s) 1502.

Electronic storage 1528 may comprise non-transitory storage media that electronically stores information. The electronic storage media of electronic storage 1528 may include one or both of system storage that is provided integrally (i.e., substantially non-removable) with computing platform(s) 1502 and/or removable storage that is removably connectable to computing platform(s) 1502 via, for example, a port (e.g., a USB port, a firewire port, etc.) or a drive (e.g., a disk drive, etc.). Electronic storage 1528 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1528 may include one or more virtual storage resources (e.g., cloud storage, a virtual private network, and/or other virtual storage resources). Electronic storage 1528 may store software algorithms, information determined by processor(s) 1530, information received from computing platform(s) 1502, information received from remote platform(s) 1504, and/or other information that enables computing platform(s) 1502 to function as described herein.

Processor(s) 1530 may be configured to provide information processing capabilities in computing platform(s) 1502. As such, processor(s) 1530 may include one or more of a digital processor, an analog processor, a digital circuit designed to process information, an analog circuit designed to process information, a state machine, and/or other mechanisms for electronically processing information. Although processor(s) 1530 is shown in FIG. 1 as a single entity, this is for illustrative purposes only. In some implementations, processor(s) 1530 may include a plurality of processing units. These processing units may be physically located within the same device, or processor(s) 1530 may represent processing functionality of a plurality of devices operating in coordination. Processor(s) 1530 may be configured to execute modules 1508, 1510, 1512, 1514, 1516, 1518, 1520, 1522, and/or 1524, and/or other modules. Processor(s) 130 may be configured to execute modules 1508, 1510, 1512, 1514, 1516, 1518, 1520, 1522, and/or 1524, and/or other modules by software; hardware; firmware; some combination of software, hardware, and/or firmware; and/or other mechanisms for configuring processing capabilities on processor(s) 1530. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 1508, 1510, 1512, 1514, 1516, 1518, 1520, 1522, and/or 1524 are illustrated in FIG. 15 as being implemented within a single processing unit, in implementations in which processor(s) 1530 includes multiple processing units, one or more of modules 1508, 1510, 1512, 1514, 1516, 1518, 1520, 1522, and/or 1524 may be implemented remotely from the other modules. The description of the functionality provided by the different modules 1508, 1510, 1512, 1514, 1516, 1518, 1520, 1522, and/or 1524 described below is for illustrative purposes, and is not intended to be limiting, as any of modules 1508, 1510, 1512, 1514, 1516, 1518, 1520, 1522, and/or 1524 may provide more or less functionality than is described. For example, one or more of modules 1508, 1510, 1512, 1514, 1516, 1518, 1520, 1522, and/or 1524 may be eliminated, and some or all of its functionality may be provided by other ones of modules 1508, 1510, 1512, 1514, 1516, 1518, 1520, 1522, and/or 1524. As another example, processor(s) 1530 may be configured to execute one or more additional modules that may perform some or all of the functionality attributed below to one of modules 1508, 1510, 1512, 1514, 1516, 1518, 1520, 1522, and/or 1524.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example, and not by way of limitation, a first user may share an object to the social-networking system. The object may be associated with a concept node connected to a user node of the first user by an edge. The first user may specify privacy settings that apply to a particular edge connecting to the concept node of the object or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example, and not by way of limitation, one or more objects may be visible to a user's “Trending” page. In particular embodiments, an object may correspond to a particular user. The object may be content associated with the particular user or may be the particular user's account or information stored on the social-networking system, or other computing system. As an example, and not by way of limitation, a first user may view one or more second users of an online social network through a “People You May Know” function of the online social network, or by viewing a list of friends of the first user. As an example, and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example, and not by way of limitation, a first user may specify that other users who attend the same university as the first user may view the first user's pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example, and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example, and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example, and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example, and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example, and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example, and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example, and not by way of limitation, the social-networking system may send a reminder to the user to confirm his or her privacy settings every six months or after every ten photo posts. In particular embodiments, privacy settings may also allow users to control access to the objects or information on a per-request basis. As an example, and not by way of limitation, the social-networking system may notify the user whenever a third-party system attempts to access information associated with the user, and require the user to provide verification that access should be allowed before proceeding.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

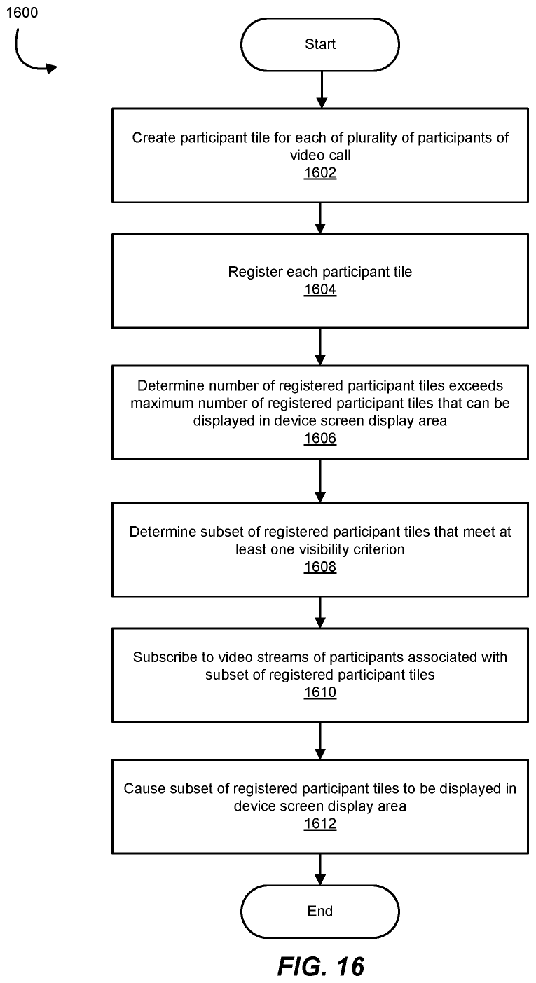

FIG. 16 an example flow diagram (e.g., process 1600) for a visibility-based subscription for video, according to certain aspects of the disclosure. For explanatory purposes, the example process 1600 is described herein with reference to FIG. 16. Further for explanatory purposes, the steps of the example process 1600 are described herein as occurring in serial, or linearly. However, multiple instances of the example process 1600 may occur in parallel. For purposes of explanation of the subject technology, the process 1600 will be discussed in reference to FIG. 15.

At step 1602, the process 1600 may include creating a participant tile for each of a plurality of participants of a video call. Each participant tile may be associated with a video stream of a participant of the plurality of participants. At step 1604, the process 1600 may include registering each participant tile. At step 1606, the process 1600 may include determining a number of registered participant tiles exceeds a maximum number of registered participant tiles that can be displayed in a device screen display area. At step 1608, the process 1600 may include determining a subset of the registered participant tiles that meet at least one visibility criterion. At step 1610, the process 1600 may include subscribing to the video streams of the participants associated with the subset of registered participant tiles. At step 1612, the process 1600 may include causing the subset of registered participant tiles to be displayed in the device screen display area.

For example, as described above in relation to FIG. 15, at step 1602, the process 1600 may include creating a participant tile for each of a plurality of participants of a video call, through participant tile creating module 1508. Each participant tile may be associated with a video stream of a participant of the plurality of participants. At step 1604, the process 1600 may include registering each participant tile, through participant tile registering module 110. At step 1606, the process 1600 may include determining a number of registered participant tiles exceeds a maximum number of registered participant tiles that can be displayed in a device screen display area, through number determination module 1512. At step 1608, the process 1600 may include determining a subset of the registered participant tiles that meet at least one visibility criterion, through subset determination module 1514. At step 1610, the process 1600 may include subscribing to the video streams of the participants associated with the subset of registered participant tiles, through stream subscription module 1516. At step 1612, the process 1600 may include causing the subset of registered participant tiles to be displayed in the device screen display area, through subset causing module 1518.

According to an aspect, the process 1600 may include determining that a registered participant tile of the subset of registered participant tiles no longer meets the at least one visibility criterion. According to an aspect, the process 1600 may include unsubscribing from the video stream of the participant associated with the registered participant tile.

According to an aspect, the process 1600 may include determining that a new registered participant tile meets the at least one visibility criterion. According to an aspect, the process 1600 may include subscribing to the video stream of a participant associated with the new registered participant tile.

According to an aspect, determining the subset of the registered participant tiles that meet the at least one visibility criterion comprises determining the subset of the registered participant tiles using impression tracking.

According to an aspect, the at least one visibility criterion includes a proportion of an area of a registered participant tile that is visible on the device screen display.

According to an aspect, the process 1600 may include periodically polling the screen display area for updates regarding which registered participant tiles meet the at least one visibility criterion.

According to an aspect, polling the screen display area for updates regarding which registered participant tiles meet the at least one visibility criterion comprises polling the screen display area every 100 milliseconds.

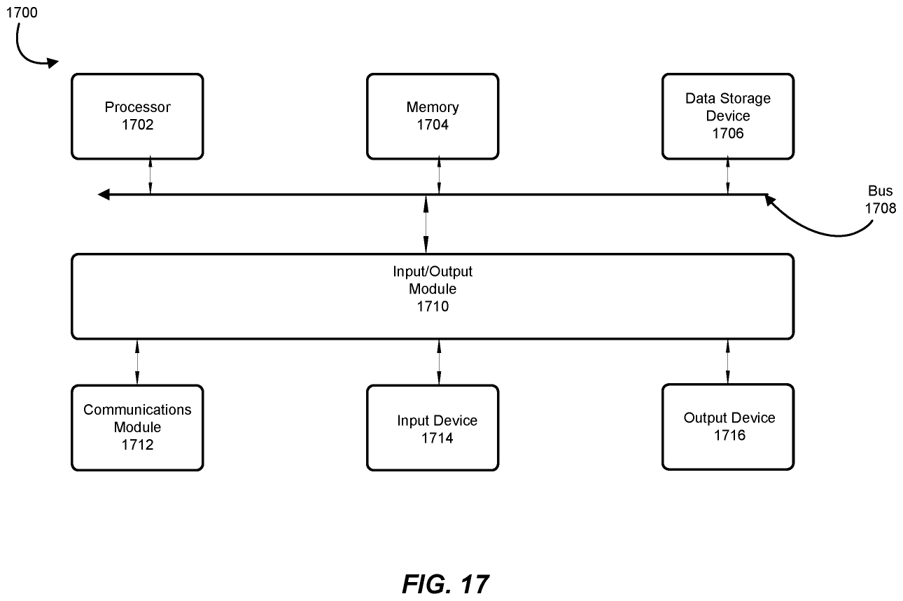

FIG. 17 is a block diagram illustrating an exemplary computer system 1700 with which aspects of the subject technology can be implemented. In certain aspects, the computer system 1700 may be implemented using hardware or a combination of software and hardware, either in a dedicated server, integrated into another entity, or distributed across multiple entities.

Computer system 1700 (e.g., server and/or client) includes a bus 1708 or other communication mechanism for communicating information, and a processor 1702 coupled with bus 1708 for processing information. By way of example, the computer system 1700 may be implemented with one or more processors 1702. Processor 1702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1700 can include, in addition to hardware, code that creates an execution environment for the computer program in question, e.g., code that constitutes processor firmware, a protocol stack, a database management system, an operating system, or a combination of one or more of them stored in an included memory 1704, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1708 for storing information and instructions to be executed by processor 1702. The processor 1702 and the memory 1704 can be supplemented by, or incorporated in, special purpose logic circuitry.

The instructions may be stored in the memory 1704 and implemented in one or more computer program products, i.e., one or more modules of computer program instructions encoded on a computer-readable medium for execution by, or to control the operation of, the computer system 1700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1704 may also be used for storing temporary variable or other intermediate information during execution of instructions to be executed by processor 1702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1700 further includes a data storage device 1706 such as a magnetic disk or optical disk, coupled to bus 1708 for storing information and instructions. Computer system 1700 may be coupled via input/output module 1710 to various devices. The input/output module 1710 can be any input/output module. Exemplary input/output modules 1710 include data ports such as USB ports. The input/output module 1710 is configured to connect to a communications module 1712. Exemplary communications modules 1712 include networking interface cards, such as Ethernet cards and modems. In certain aspects, the input/output module 1710 is configured to connect to a plurality of devices, such as an input device 1714 and/or an output device 1716. Exemplary input devices 1714 include a keyboard and a pointing device, e.g., a mouse or a trackball, by which a user can provide input to the computer system 1700. Other kinds of input devices 1714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1716 include display devices such as an LCD (liquid crystal display) monitor, for displaying information to the user.

According to one aspect of the present disclosure, the above-described gaming systems can be implemented using a computer system 1700 in response to processor 1702 executing one or more sequences of one or more instructions contained in memory 1704. Such instructions may be read into memory 1704 from another machine-readable medium, such as data storage device 1706. Execution of the sequences of instructions contained in the main memory 1704 causes processor 1702 to perform the process steps described herein. One or more processors in a multi-processing arrangement may also be employed to execute the sequences of instructions contained in memory 1704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1700 can include clients and servers. A client and server are generally remote from each other and typically interact through a communication network. The relationship of client and server arises by virtue of computer programs running on the respective computers and having a client-server relationship to each other. Computer system 1700 can be, for example, and without limitation, a desktop computer, laptop computer, or tablet computer. Computer system 1700 can also be embedded in another device, for example, and without limitation, a mobile telephone, a PDA, a mobile audio player, a GPS receiver, a video game console, and/or a television set top box.

The term “machine-readable storage medium” or “computer-readable medium” as used herein refers to any medium or media that participates in providing instructions to processor 1702 for execution. Such a medium may take many forms, including, but not limited to, non-volatile media, volatile media, and transmission media. Non-volatile media include, for example, optical or magnetic disks, such as data storage device 1706. Volatile media include dynamic memory, such as memory 1704. Transmission media include coaxial cables, copper wire, and fiber optics, including the wires that comprise bus 1708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1700 reads game data and provides a game, information may be read from the game data and stored in a memory device, such as the memory 1704. Additionally, data from the memory 1704 servers accessed via a network the bus 1708, or the data storage device 1706 may be read and loaded into the memory 1704. Although data is described as being found in the memory 1704, it will be understood that data does not have to be stored in the memory 1704 and may be stored in other memory accessible to the processor 1702 or distributed among several media, such as the data storage device 1706.

### Example Embodiments

In some embodiments, a computer-implemented method for detecting malicious usage may include receiving, from a wearable computing device, an analytics report comprising usage data, generating a malicious usage prediction by applying a trained user model to aggregations of the usage data, and causing the wearable computing device to perform a security action based on the malicious usage prediction.

In some embodiments, a computer-implemented method for selecting optimal image frames may include (a) identifying a set of image frames stored in a memory buffer, (b) measuring, for each frame in the set of image frames, a sharpness value of the frame, (c) designating the frame with a highest sharpness value out of the set of image frames as an optimal frame, and (d) storing the optimal frame to memory that does not comprise the memory buffer.

In some examples, measuring the sharpness value of the frame may include retrieving luminance data of the frame and measuring the sharpness value based on the luminance data of the frame.

In some embodiments, measuring the sharpness value of the frame may include mitigating noise by downscaling the frame.

In some examples, measuring the sharpness value of the frame may include calculating a vertical diff of the frame, calculating a horizontal diff of the frame, and summing the vertical diff and the horizontal diff to arrive at the sharpness value.

In some embodiments, identifying the set of image frames stored in the memory buffer may include identifying image frames captured by a camera recording streaming image data.

In some examples, storing the optimal frame to the memory may be in response to receiving user input that triggers frame storage.

A computer-implemented method for augmenting media to preserve quality and privacy may include (a) receiving media content, (b) performing segmentation on the received media content, (c) detecting, based on the segmentation, a privacy portion of the media content, (d) generating synthetic data corresponding to the privacy portion, and (e) replacing, in the media content, the privacy portion with the synthetic data to generate augmented media content.

In some examples, the segmentation may include at least one of pose segmentation, face segmentation, address segmentation, surroundings segmentation, voice segmentation, or license plate segmentation.

In some examples, detecting the privacy portion may be based on a privacy score applied to each segmented element. In some examples, the privacy score may be based on at least one of a face orientation, a media metadata, a location, or user settings. In some examples, the user settings may include user selected persons or objects that are not considered private.

In some examples, the synthetic data may be generated by a generative adversarial network (GAN). In some examples, the synthetic data may be generated locally. In some examples, the media content may be received and stored locally. In some examples, the method may further include uploading the augmented media content to a remote device.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world or that visually immerses a user in an artificial reality. While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

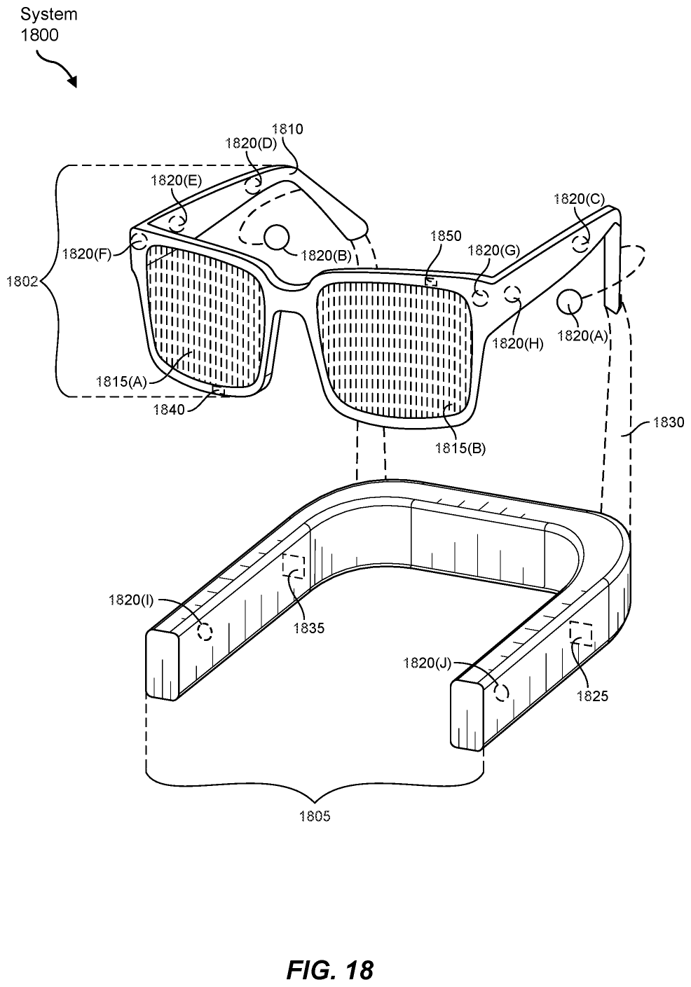

Turning to FIG. 18, an augmented-reality system 1800 can include a frame 1810 configured to hold a left display device 1815(A) and a right display device 1815(B) in front of a user's eyes. Display devices 1815(A) and 1815(B) may act together or independently to present an image or series of images to a user. While the eyewear device 1802 includes two displays, embodiments of this disclosure may be implemented in augmented-reality systems with a single NED or more than two NEDs.

In some embodiments, augmented-reality system 1800 may include one or more sensors, such as sensor 1840. Sensor 1840 may generate measurement signals in response to motion of augmented-reality system 1800 and may be located on substantially any portion of frame 1810. Sensor 1840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1800 may or may not include sensor 1840 or may include more than one sensor. In embodiments in which sensor 1840 includes an IMU, the IMU may generate calibration data based on measurement signals from sensor 1840. Examples of sensor 1840 may include, without limitation, accelerometers, gyroscopes, magnetometers, other suitable types of sensors that detect motion, sensors used for error correction of the IMU, or some combination thereof.

In some examples, augmented-reality system 1800 may also include a microphone array with a plurality of acoustic transducers 1820(A)-1820(J), referred to collectively as acoustic transducers 1820. Acoustic transducers 1820 may represent transducers that detect air pressure variations induced by sound waves. Each acoustic transducer 1820 may be configured to detect sound and convert the detected sound into an electronic format (e.g., an analog or digital format). The microphone array in FIG. 18 may include, for example, ten acoustic transducers: 1820(A) and 1820(B), which may be designed to be placed inside a corresponding ear of the user, acoustic transducers 1820(C), 1820(D), 1820(E), 1820(F), 1820(G), and 1820(H), which may be positioned at various locations on frame 1810, and/or acoustic transducers 1820(I) and 1820(J), which may be positioned on a corresponding neckband 1805.

In some embodiments, one or more of acoustic transducers 1820(A)-(J) may be used as output transducers (e.g., speakers). For example, acoustic transducers 1820(A) and/or 1820(B) may be earbuds or any other suitable type of headphone or speaker.

The configuration of acoustic transducers 1820 of the microphone array may vary. While augmented-reality system 1800 is shown in FIG. 18 as having ten acoustic transducers 1820, the number of acoustic transducers 1820 may be greater or less than ten. In some embodiments, using higher numbers of acoustic transducers 1820 may increase the amount of audio information collected and/or the sensitivity and accuracy of the audio information. In contrast, using a lower number of acoustic transducers 1820 may decrease the computing power required by an associated controller 1850 to process the collected audio information. In addition, the position of each acoustic transducer 1820 of the microphone array may vary. For example, the position of an acoustic transducer 1820 may include a defined position on the user, a defined coordinate on frame 1810, an orientation associated with each acoustic transducer 1820, or some combination thereof.

Acoustic transducers 1820(A) and 1820(B) may be positioned on different parts of the user's ear, such as behind the pinna, behind the tragus, and/or within the auricle or fossa. Or, there may be additional acoustic transducers 1820 on or surrounding the ear in addition to acoustic transducers 1820 inside the ear canal. Having an acoustic transducer 1820 positioned next to an ear canal of a user may enable the microphone array to collect information on how sounds arrive at the ear canal. By positioning at least two of acoustic transducers 1820 on either side of a user's head (e.g., as binaural microphones), augmented-reality system 1800 may simulate binaural hearing and capture a 3D stereo sound field around about a user's head. In some embodiments, acoustic transducers 1820(A) and 1820(B) may be connected to augmented-reality system 1800 via a wired connection 1830, and in other embodiments acoustic transducers 1820(A) and 1820(B) may be connected to augmented-reality system 1800 via a wireless connection (e.g., a Bluetooth connection). In still other embodiments, acoustic transducers 1820(A) and 1820(B) may not be used at all in conjunction with augmented-reality system 1800.

Acoustic transducers 1820 on frame 1810 may be positioned in a variety of different ways, including along the length of the temples, across the bridge, above or below display devices 1815(A) and 1815(B), or some combination thereof. Acoustic transducers 1820 may also be oriented such that the microphone array is able to detect sounds in a wide range of directions surrounding the user wearing the augmented-reality system 1800. In some embodiments, an optimization process may be performed during manufacturing of augmented-reality system 1800 to determine relative positioning of each acoustic transducer 1820 in the microphone array.

In some examples, augmented-reality system 1800 may include or be connected to an external device (e.g., a paired device), such as neckband 1805. Neckband 1805 generally represents any type or form of paired device. Thus, the following discussion of neckband 1805 may also apply to various other paired devices, such as charging cases, smart watches, smart phones, wrist bands, other wearable devices, hand-held controllers, tablet computers, laptop computers, other external compute devices, etc.

As shown, neckband 1805 may be coupled to eyewear device 1802 via one or more connectors. The connectors may be wired or wireless and may include electrical and/or non-electrical (e.g., structural) components. In some cases, eyewear device 1802 and neckband 1805 may operate independently without any wired or wireless connection between them. While FIG. 18 illustrates the components of eyewear device 1802 and neckband 1805 in example locations on eyewear device 1802 and neckband 1805, the components may be located elsewhere and/or distributed differently on eyewear device 1802 and/or neckband 1805. In some embodiments, the components of eyewear device 1802 and neckband 1805 may be located on one or more additional peripheral devices paired with eyewear device 1802, neckband 1805, or some combination thereof.

Pairing external devices, such as neckband 1805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1800 may be provided by a paired device or shared between a paired device and an eyewear device, thus reducing the weight, heat profile, and form factor of the eyewear device overall while still retaining desired functionality. For example, neckband 1805 may allow components that would otherwise be included on an eyewear device to be included in neckband 1805 since users may tolerate a heavier weight load on their shoulders than they would tolerate on their heads. Neckband 1805 may also have a larger surface area over which to diffuse and disperse heat to the ambient environment. Thus, neckband 1805 may allow for greater battery and computation capacity than might otherwise have been possible on a stand-alone eyewear device. Since weight carried in neckband 1805 may be less invasive to a user than weight carried in eyewear device 1802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1805 may be communicatively coupled with eyewear device 1802 and/or to other devices. These other devices may provide certain functions (e.g., tracking, localizing, depth mapping, processing, storage, etc.) to augmented-reality system 1800. In the embodiment of FIG. 18, neckband 1805 may include two acoustic transducers (e.g., 1820(I) and 1820(J)) that are part of the microphone array (or potentially form their own microphone subarray). Neckband 1805 may also include a controller 1825 and a power source 1835.

Acoustic transducers 1820(I) and 1820(J) of neckband 1805 may be configured to detect sound and convert the detected sound into an electronic format (analog or digital). In the embodiment of FIG. 18, acoustic transducers 1820(I) and 1820(J) may be positioned on neckband 1805, thereby increasing the distance between the neckband acoustic transducers 1820(I) and 1820(J) and other acoustic transducers 1820 positioned on eyewear device 1802. In some cases, increasing the distance between acoustic transducers 1820 of the microphone array may improve the accuracy of beamforming performed via the microphone array. For example, if a sound is detected by acoustic transducers 1820(C) and 1820(D) and the distance between acoustic transducers 1820(C) and 1820(D) is greater than, e.g., the distance between acoustic transducers 1820(D) and 1820(E), the determined source location of the detected sound may be more accurate than if the sound had been detected by acoustic transducers 1820(D) and 1820(E).

Controller 1825 of neckband 1805 may process information generated by the sensors on neckband 1805 and/or augmented-reality system 1800. For example, controller 1825 may process information from the microphone array that describes sounds detected by the microphone array. For each detected sound, controller 1825 may perform a direction-of-arrival (DOA) estimation to estimate a direction from which the detected sound arrived at the microphone array. As the microphone array detects sounds, controller 1825 may populate an audio data set with the information. In embodiments in which augmented-reality system 1800 includes an inertial measurement unit, controller 1825 may compute all inertial and spatial calculations from the IMU located on eyewear device 1802. A connector may convey information between augmented-reality system 1800 and neckband 1805 and between augmented-reality system 1800 and controller 1825. The information may be in the form of optical data, electrical data, wireless data, or any other transmittable data form. Moving the processing of information generated by augmented-reality system 1800 to neckband 1805 may reduce weight and heat in eyewear device 1802, making it more comfortable to the user.

Power source 1835 in neckband 1805 may provide power to eyewear device 1802 and/or to neckband 1805. Power source 1835 may include, without limitation, lithium ion batteries, lithium-polymer batteries, primary lithium batteries, alkaline batteries, or any other form of power storage. In some cases, power source 1835 may be a wired power source. Including power source 1835 on neckband 1805 instead of on eyewear device 1802 may help better distribute the weight and heat generated by power source 1835.

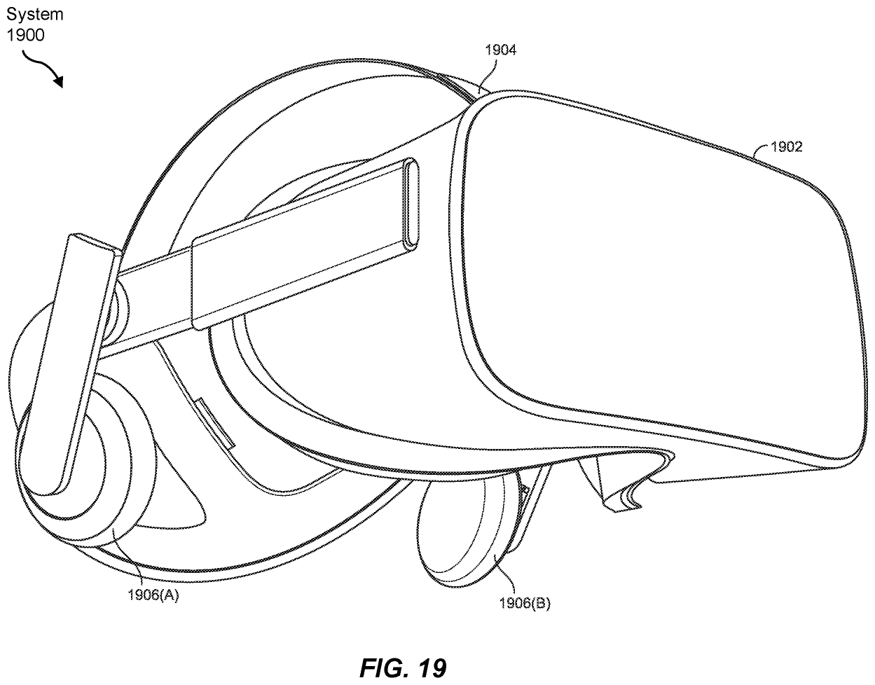

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1900 in FIG. 19, that mostly or completely covers a user's field of view. Virtual-reality system 1900 may include a front rigid body 1902 and a band 1904 shaped to fit around a user's head. Virtual-reality system 1900 may also include output audio transducers 1906(A) and 1906(B). Furthermore, while not shown in FIG. 19, front rigid body 1902 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1800 and/or virtual-reality system 1900 may include one or more LCDs, LED displays, microLED displays, organic LED displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1800 and/or virtual-reality system 1900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1800 and/or virtual-reality system 1900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

Some augmented reality systems may map a user's and/or device's environment using techniques referred to as “simultaneous location and mapping” (SLAM). SLAM mapping and location identifying techniques may involve a variety of hardware and software tools that can create or update a map of an environment while simultaneously keeping track of a user's location within the mapped environment. SLAM may use many different types of sensors to create a map and determine a user's position within the map.

SLAM techniques may, for example, implement optical sensors to determine a user's location. Radios including WiFi, Bluetooth, GPS, cellular or other communication devices may be also used to determine a user's location relative to a radio transceiver or group of transceivers (e.g., a WiFi router or group of GPS satellites). Acoustic sensors such as microphone arrays or 2D or 3D sonar sensors may also be used to determine a user's location within an environment. Augmented reality and virtual reality devices (such as systems 1800 and 1900 of FIGS. 18 and 19, respectively) may incorporate any or all of these types of sensors to perform SLAM operations such as creating and continually updating maps of the user's current environment. In at least some of the embodiments described herein, SLAM data generated by these sensors may be referred to as “environmental data” and may indicate a user's current environment. This data may be stored in a local or remote data store (e.g., a cloud data store) and may be provided to a user's AR/VR device on demand.

When the user is wearing an augmented reality headset or virtual reality headset in a given environment, the user may be interacting with other users or other electronic devices that serve as audio sources. In some cases, it may be desirable to determine where the audio sources are located relative to the user and then present the audio sources to the user as if they were coming from the location of the audio source. The process of determining where the audio sources are located relative to the user may be referred to as “localization,” and the process of rendering playback of the audio source signal to appear as if it is coming from a specific direction may be referred to as “spatialization.”

Localizing an audio source may be performed in a variety of different ways. In some cases, an augmented reality or virtual reality headset may initiate a DOA analysis to determine the location of a sound source. The DOA analysis may include analyzing the intensity, spectra, and/or arrival time of each sound at the artificial reality device to determine the direction from which the sounds originated. The DOA analysis may include any suitable algorithm for analyzing the surrounding acoustic environment in which the artificial reality device is located.

For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

In some embodiments, different users may perceive the source of a sound as coming from slightly different locations. This may be the result of each user having a unique head-related transfer function (HRTF), which may be dictated by a user's anatomy including ear canal length and the positioning of the ear drum. The artificial reality device may provide an alignment and orientation guide, which the user may follow to customize the sound signal presented to the user based on their unique HRTF. In some embodiments, an artificial reality device may implement one or more microphones to listen to sounds within the user's environment. The augmented reality or virtual reality headset may use a variety of different array transfer functions (e.g., any of the DOA algorithms identified above) to estimate the direction of arrival for the sounds. Once the direction of arrival has been determined, the artificial reality device may play back sounds to the user according to the user's unique HRTF. Accordingly, the DOA estimation generated using the array transfer function (ATF) may be used to determine the direction from which the sounds are to be played from. The playback sounds may be further refined based on how that specific user hears sounds according to the HRTF.

In addition to or as an alternative to performing a DOA estimation, an artificial reality device may perform localization based on information received from other types of sensors. These sensors may include cameras, IR sensors, heat sensors, motion sensors, GPS receivers, or in some cases, sensors that detect a user's eye movements. For example, as noted above, an artificial reality device may include an eye tracker or gaze detector that determines where the user is looking. Often, the user's eyes will look at the source of the sound, if only briefly. Such clues provided by the user's eyes may further aid in determining the location of a sound source. Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time.

Some embodiments may implement the determined DOA to generate a more customized output audio signal for the user. For instance, an “acoustic transfer function” may characterize or define how a sound is received from a given location. More specifically, an acoustic transfer function may define the relationship between parameters of a sound at its source location and the parameters by which the sound signal is detected (e.g., detected by a microphone array or detected by a user's ear). An artificial reality device may include one or more acoustic sensors that detect sounds within range of the device. A controller of the artificial reality device may estimate a DOA for the detected sounds (using, e.g., any of the methods identified above) and, based on the parameters of the detected sounds, may generate an acoustic transfer function that is specific to the location of the device. This customized acoustic transfer function may thus be used to generate a spatialized output audio signal where the sound is perceived as coming from a specific location.

Indeed, once the location of the sound source or sources is known, the artificial reality device may re-render (i.e., spatialize) the sound signals to sound as if coming from the direction of that sound source. The artificial reality device may apply filters or other digital signal processing that alter the intensity, spectra, or arrival time of the sound signal. The digital signal processing may be applied in such a way that the sound signal is perceived as originating from the determined location. The artificial reality device may amplify or subdue certain frequencies or change the time that the signal arrives at each ear. In some cases, the artificial reality device may create an acoustic transfer function that is specific to the location of the device and the detected direction of arrival of the sound signal. In some embodiments, the artificial reality device may re-render the source signal in a stereo device or multi-speaker device (e.g., a surround sound device). In such cases, separate and distinct audio signals may be sent to each speaker. Each of these audio signals may be altered according to the user's HRTF and according to measurements of the user's location and the location of the sound source to sound as if they are coming from the determined location of the sound source. Accordingly, in this manner, the artificial reality device (or speakers associated with the device) may re-render an audio signal to sound as if originating from a specific location.

As noted, artificial reality systems 1800 and 1900 may be used with a variety of other types of devices to provide a more compelling artificial reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

As noted, reality systems 1800 and 1900 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

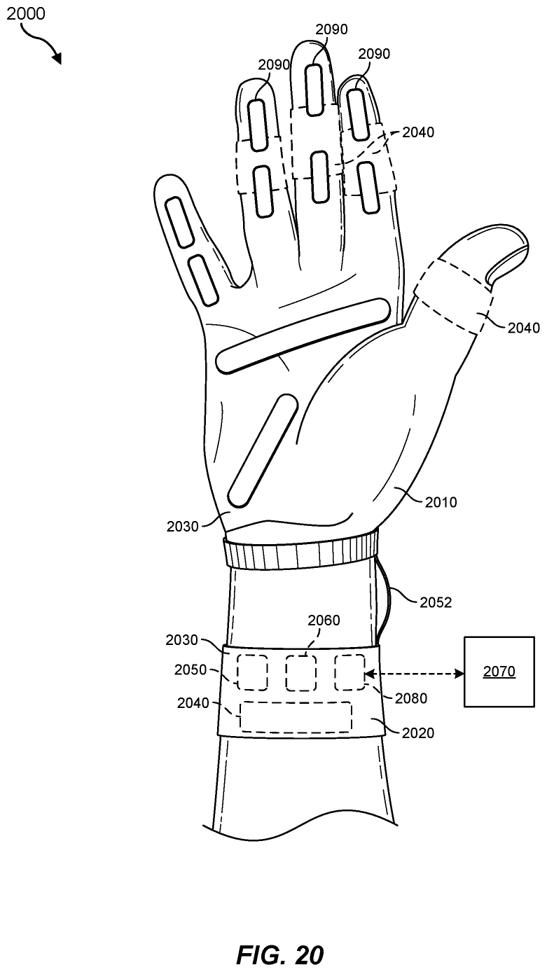

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 20 illustrates a vibrotactile system 2000 in the form of a wearable glove (haptic device 2010) and wristband (haptic device 2020). Haptic device 2010 and haptic device 2020 are shown as examples of wearable devices that include a flexible, wearable textile material 2030 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 2040 may be positioned at least partially within one or more corresponding pockets formed in textile material 2030 of vibrotactile system 2000. Vibrotactile devices 2040 may be positioned in locations to provide a vibrating sensation (e.g., haptic feedback) to a user of vibrotactile system 2000. For example, vibrotactile devices 2040 may be positioned against the user's finger(s), thumb, or wrist, as shown in FIG. 20. Vibrotactile devices 2040 may, in some examples, be sufficiently flexible to conform to or bend with the user's corresponding body part(s).

A power source 2050 (e.g., a battery) for applying a voltage to the vibrotactile devices 2040 for activation thereof may be electrically coupled to vibrotactile devices 2040, such as via conductive wiring 2052. In some examples, each of vibrotactile devices 2040 may be independently electrically coupled to power source 2050 for individual activation. In some embodiments, a processor 2060 may be operatively coupled to power source 2050 and configured (e.g., programmed) to control activation of vibrotactile devices 2040.

Vibrotactile system 2000 may be implemented in a variety of ways. In some examples, vibrotactile system 2000 may be a standalone system with integral subsystems and components for operation independent of other devices and systems. As another example, vibrotactile system 2000 may be configured for interaction with another device or system 2070. For example, vibrotactile system 2000 may, in some examples, include a communications interface 2080 for receiving and/or sending signals to the other device or system 2070. The other device or system 2070 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 2080 may enable communications between vibrotactile system 2000 and the other device or system 2070 via a wireless (e.g., Wi-Fi, Bluetooth, cellular, radio, etc.) link or a wired link. If present, communications interface 2080 may be in communication with processor 2060, such as to provide a signal to processor 2060 to activate or deactivate one or more of the vibrotactile devices 2040.

Vibrotactile system 2000 may optionally include other subsystems and components, such as touch-sensitive pads 2090, pressure sensors, motion sensors, position sensors, lighting elements, and/or user interface elements (e.g., an on/off button, a vibration control element, etc.). During use, vibrotactile devices 2040 may be configured to be activated for a variety of different reasons, such as in response to the user's interaction with user interface elements, a signal from the motion or position sensors, a signal from the touch-sensitive pads 2090, a signal from the pressure sensors, a signal from the other device or system 2070, etc.

Although power source 2050, processor 2060, and communications interface 2080 are illustrated in FIG. 20 as being positioned in haptic device 2020, the present disclosure is not so limited. For example, one or more of power source 2050, processor 2060, or communications interface 2080 may be positioned within haptic device 2010 or within another wearable textile.

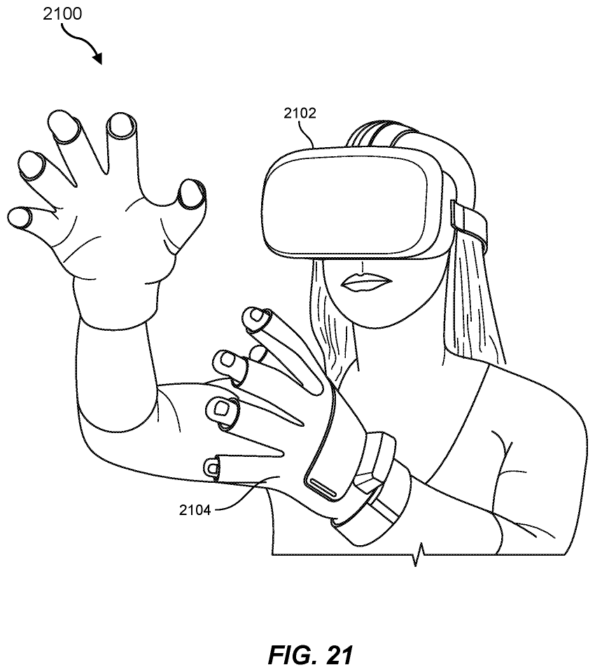

Haptic wearables, such as those shown in and described in connection with FIG. 20, may be implemented in a variety of types of artificial-reality systems and environments. FIG. 21 shows an example artificial-reality environment 2100 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 2102 generally represents any type or form of virtual-reality system, such as the vibrotactile system 2000 in FIG. 20. Haptic device 2104 generally represents any type or form of wearable device, worn by a user of an artificial-reality system, that provides haptic feedback to the user to give the user the perception that he or she is physically engaging with a virtual object. In some embodiments, haptic device 2104 may provide haptic feedback by applying vibration, motion, and/or force to the user. For example, haptic device 2104 may limit or augment a user's movement. To give a specific example, haptic device 2104 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 2104 to send action requests to a console. Examples of action requests include, without limitation, requests to start an application and/or end the application and/or requests to perform a particular action within the application.

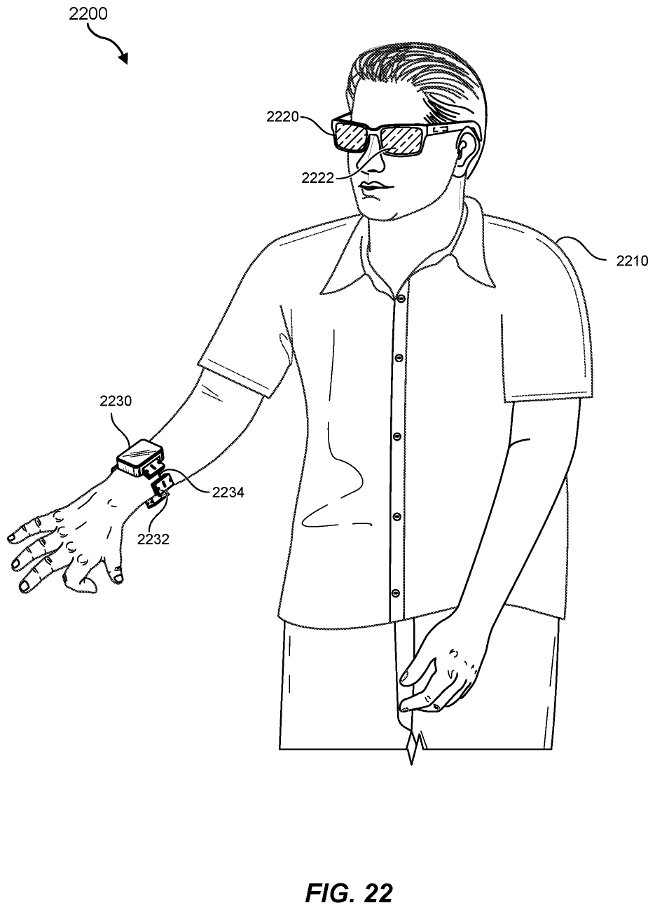

While haptic interfaces may be used with virtual-reality systems, as shown in FIG. 21, haptic interfaces may also be used with augmented-reality systems, as shown in FIG. 22. FIG. 22 is a perspective view of a user 2210 interacting with an augmented-reality system 2200. In this example, user 2210 may wear a pair of augmented-reality glasses 2220 that may have one or more displays 2222 and that are paired with a haptic device 2230. In this example, haptic device 2230 may be a wristband that includes a plurality of band elements 2232 and a tensioning mechanism 2234 that connects band elements 2232 to one another.

One or more of band elements 2232 may include any type or form of actuator suitable for providing haptic feedback. For example, one or more of band elements 2232 may be configured to provide one or more of various types of cutaneous feedback, including vibration, force, traction, texture, and/or temperature. To provide such feedback, band elements 2232 may include one or more of various types of actuators. In one example, each of band elements 2232 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 2010, 2020, 2104, and 2230 may include any suitable number and/or type of haptic transducer, sensor, and/or feedback mechanism. For example, haptic devices 2010, 2020, 2104, and 2230 may include one or more mechanical transducers, piezoelectric transducers, and/or fluidic transducers. Haptic devices 2010, 2020, 2104, and 2230 may also include various combinations of different types and forms of transducers that work together or independently to enhance a user's artificial-reality experience. In one example, each of band elements 2232 of haptic device 2230 may include a vibrotactor (e.g., a vibrotactile actuator) configured to vibrate in unison or independently to provide one or more of various types of haptic sensations to a user.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

In some embodiments, one or more objects (e.g., data associated with sensors, and/or activity information) of a computing system may be associated with one or more privacy settings. These objects may be stored on or otherwise associated with any suitable computing system or application, such as, for example, a social-networking system, a client system, a third-party system, a messaging application, a photo-sharing application, a biometric data acquisition application, an artificial-reality application, and/or any other suitable computing system or application.

Privacy settings (or “access settings”) for an object may be stored in any suitable manner; such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within an application (such as an artificial-reality application). When privacy settings for an object allow a particular user or other entity to access that object, the object may be described as being “visible” with respect to that user or other entity. As an example, a user of an artificial-reality application may specify privacy settings for a user-profile page that identify a set of users that may access the artificial-reality application information on the user-profile page, thus excluding other users from accessing that information. As another example, an artificial-reality application may store privacy policies/guidelines. The privacy policies/guidelines may specify what information of users may be accessible by which entities and/or by which processes (e.g., internal research, advertising algorithms, machine-learning algorithms), thus ensuring only certain information of the user may be accessed by certain entities or processes.

In some embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of an online social network may specify privacy settings for a user-profile page that identify a set of users that may access work-experience information on the user-profile page, thus excluding other users from accessing that information.

In some embodiments, privacy settings for an object may specify a “blocked list” of users or other entities that should not be allowed to access certain information associated with the object. In some cases, the blocked list may include third-party entities. The blocked list may specify one or more users or entities for which an object is not visible.

Privacy settings associated with an object may specify any suitable granularity of permitted access or denial of access. As an example, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. In some embodiments, different objects of the same type associated with a user may have different privacy settings. In addition, one or more default privacy settings may be set for each object of a particular object-type.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A plurality of methods comprising:
a method for detecting malicious usage of wearable devices comprising:
receiving, from a wearable computing device, an analytics report comprising usage data;
generating a malicious usage prediction by applying a trained user model to aggregations of the usage data; and
causing the wearable computing device to perform a security action based on the malicious usage prediction;
a method for camera frame selection comprising:
identifying a set of image frames stored in a memory buffer;
measuring, for each frame in the set of image frames, a sharpness value of the frame;
designating the frame with a highest sharpness value out of the set of image frames as an optimal frame; and
storing the optimal frame to memory that does not comprise the memory buffer;
a method for preserving media quality comprising:
receiving media content;
performing segmentation on the received media content;
detecting, based on the segmentation, a privacy portion of the media content;
generating synthetic data corresponding to the privacy portion; and
replacing, in the media content, the privacy portion with the synthetic data to generate augmented media content;
a method for using color change patterns for device pairing comprising:
generating, at a first device, a unique number;
converting, at the first device, the unique number to a color sequence pattern; and
transmitting, from the first device, the color sequence pattern via one or more lights;
a method of using technical solutions to enhance social acceptability comprising:
detecting a bystander within range of a sensor of a mobile computing device;
determining, based on one or more privacy policies associated with the bystander or the mobile computing device, whether capturing of information associated with the bystander using the sensor is authorized;
when capturing of information associated with the bystander is authorized, capturing information associated with the bystander; and
when capturing of information associated with the bystander is not authorized, refraining from capturing the information associated with the bystander; or
a method for a visibility-based subscription for video calls, the method comprising:
creating a participant tile for each of a plurality of participants of a video call, each participant tile being associated with a video stream of a participant of the plurality of participants;
registering each participant tile;
determining a number of registered participant tiles exceeds a maximum number of registered participant tiles that can be displayed in a device screen display area;
determining a subset of the registered participant tiles that meet at least one visibility criterion;
subscribing to the video streams of the participants associated with the subset of registered participant tiles; and
causing the subset of registered participant tiles to be displayed in the device screen display area.

2. The computer-implemented method of claim 1, wherein measuring the sharpness value of the frame comprises:
retrieving luminance data of the frame; and
measuring the sharpness value based on the luminance data of the frame.

3. The computer-implemented method of claim 1, wherein identifying the set of image frames stored in the memory buffer comprises identifying image frames captured by a camera recording streaming image data.

4. The computer-implemented method of claim 1, wherein the segmentation includes at least one of pose segmentation, face segmentation, address segmentation, surrounding segmentation, voice segmentation, or license plate segmentation.

5. The computer-implemented method of claim 1, wherein detecting the privacy portion is based on a privacy score applied to each segmented element.

6. The computer-implemented method of claim 5, wherein the privacy score is based on at least one of a face orientation, a media metadata, a location, or user settings.

7. The computer-implemented method of claim 1, further comprising pairing the first device with another device using the unique number.

8. The computer-implemented method of claim 7, wherein pairing the first device with another device comprises broadcasting the unique number as part of a wireless advertisement packet.

9. The computer-implemented method of claim 7, wherein pairing the first device with another device comprises detecting that the unique number is part of a received wireless advertisement packet transmitted by another device.

10. The computer-implemented method of claim 1, further comprising transmitting to an additional mobile computing device of the bystander an indication of the one or more privacy policies.

11. The computer-implemented method of claim 1, further comprising:
detecting a desire of the bystander to understand the one or more privacy policies; and
emitting, in response to the desire, an auditory indication of the one or more privacy policies.

12. The computer-implemented method of claim 1, further comprising:
detecting a desire of the bystander to understand whether the mobile computing device is capturing information associated with the bystander; and
emitting, in response to the desire, an auditory indication of whether the mobile computing device is capturing information associated with the bystander.

13. The computer-implemented method of claim 1, wherein the one or more privacy policies comprise a privacy policy associated with and maintained by the bystander.

14. The computer-implemented method of claim 1, further comprising:
determining that a registered participant tile of the subset of registered participant tiles no longer meets the at least one visibility criterion; and
unsubscribing from the video stream of the participant associated with the registered participant tile.

15. The computer-implemented method of claim 14, further comprising:
determining that a new registered participant tile meets the at least one visibility criterion; and
subscribing to the video stream of a participant associated with the new registered participant tile.

16. The computer-implemented method of claim 1, wherein determining the subset of the registered participant tiles that meet the at least one visibility criterion comprises determining the subset of the registered participant tiles using impression tracking.

17. A wearable device comprising:
a surface dimensioned to fit over an interior side of a hinge joint;
a first wire extending along a surface and second wire extending along the surface; and
a processor configured to detect a difference of mutual capacitance between the first wire and the second wire, wherein the processor assesses an increase or decrease in the mutual capacitance to calculate a bend measurement.

18. The wearable device of claim 17, wherein the processor is programmed to emit a drive signal that travels from the first wire to the second wire.

19. The wearable device of claim 17, wherein the processor is programmed to store the bend measurement as a calibration value.

20. The wearable device of claim 17, wherein the processor is programmed to detect touch between the first wire and the second wire to sense a finger pinch gesture.
